(19) United States
(12) Patent Application Publication
(10) Pub. No.: US 2024/0388943 A1
(43) Pub. Date: Nov. 21, 2024

(54) METHOD AND APPARATUS FOR SENSING DETECTION IN A WIRELESS COMMUNICATION SYSTEM

(71) Applicant: Samsung Electronics Co., Ltd., Gyeonggi-do (KR)

(72) Inventors: Di SU, Beijing (CN); Chen QIAN, Beijing (CN); Peng LIN, Beijing (CN)

(21) Appl. No.: 18/664,844

(22) Filed: May 15, 2024

(30) Foreign Application Priority Data
May 15, 2023 (CN) 202310546164.3
May 15, 2023 (CN) 202310546172.8

(51) Int. Cl. H04W 24/10; H04W 16/28; H04W 64/00

(52) U.S. Cl. CPC H04W 24/10; H04W 16/28; H04W 64/00

(57) ABSTRACT

The disclosure relates to a fifth generation (5G) or sixth generation (6G) communication system for supporting a higher data transmission rate. A method performed by a first communication and sensing node in a wireless communication system includes transmitting at least one sensing signal, and performing a first sensing measurement based on the at least one sensing signal, wherein one or more of the at least one sensing signal is further used to perform a second sensing measurement by a second communication and sensing node.

### CROSS-REFERENCE TO RELATED APPLICATION(S)

This application is based on and claims priority under 35 U.S.C. § 119 (a) to Chinese Patent Application No. 202310546172.8, which was filed in the Chinese Intellectual Property Office on May 15, 2023, and Chinese Patent Application No. 202310546164.3, which was filed in the Chinese Intellectual Property Office on May 15, 2023, the entire content of each of which is incorporated herein by reference.

### BACKGROUND

### 1. Field

The disclosure relates generally to a communication field and, more particularly, to a method and apparatus for sensing detection in a wireless communication system.

### 2. Description of Related Art

Fifth generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) including 28 GHz and 39 GHz. In addition, it has been considered to implement 6G mobile communication technologies referred to as beyond 5G systems, in terahertz (THz) bands such as 95 GHz to 3THz bands, to realize transmission rates fifty times faster than 5G mobile communication technologies and ultra-low latencies one-tenth of 5G mobile communication technologies.

At the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Ongoing discussions persist regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying 2-step random access channel (2-step RACH) procedures for NR. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

To meet the increasing demand for wireless data communication services since the deployment of 4G communication systems, efforts have been made to develop improved 5G or pre-5G communication systems. Therefore, 5G or pre-5G communication systems are also referred to as beyond fourth generation (4G) networks or post-long term evolution (LTE) systems.

To achieve a higher data rate, 5G communication systems are implemented in mm Wave bands. To reduce propagation loss of radio waves and increase a transmission distance, technologies such as beam forming, MIMO, FD-MIMO, array antenna, analog beam forming and large-scale antenna are discussed in 5G communication systems.

In addition, developments of system network improvement are underway based on advanced small cell, cloud radio access network (RAN), ultra-dense network, device-to-device (D2D) communication, wireless backhaul, mobile network, cooperative communication, coordinated multi-points (COMP), and reception-end interference cancellation.

In 5G systems, hybrid frequency shift keying (FSK) and quadrature amplitude modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

With the advancement of science and technology, there is an increasing variety of communication devices. In addition to traditional devices such as a mobile phone and a computer, the communication devices may also include a mobile robot, such as a self-driving vehicle, a drone, etc. This type of mobile device often needs to have the ability to accurately position or be positioned so that it can accurately identify and react to the current situation, such as by using a similar positioning capability to that provided by radar technology. For example, a radar module may be equipped in the communication device, although the working frequency band of a communication system is gradually increasing to a higher frequency band. The communication band is also gradually nearing the radar band, making inevitable a resulting interference and resource conflict between the communication system and a radar system. One concept to solve this problem may be to consider a fusion system of communication and radar, referred to as a communication and sensing integration technology, to further enhance the function of the communication system as well as to improve the spectrum efficiency. Currently, both industry and academia are considering the communication and sensing integration as one of key technologies for a future communication system.

A core concept of the communication and sensing integration is to use the same set of hardware devices to realize a function of sensing the surrounding environment with as little resource overhead as possible, while ensuring a basic communication function. For example, a communication node is also equipped with a function of sensing, the content of sensing includes a distance, direction (angle), speed and a type of an object in the surrounding environment. Unlike the technology of locating an access terminal in the traditional communication system, the communication and sensing integration technology may also sense a variety of information about a non-access object, which greatly increases the ability of the communication system to dynamically adjust its working states (e.g., scheduling, beam management, early warning of the access terminal, etc.) according to the surrounding environment. However, the existing communication and sensing integration node suffers from low performance of sensing detection.

Therefore, there is a need in the art for a method and apparatus for multi-node sensing to improve the performance of sensing detection in wireless communications.

### SUMMARY

The disclosure has been made to address at least the above-mentioned problems and/or disadvantages and to provide at least the advantages described below.

Accordingly, an aspect of the disclosure is to provide a method and apparatus for multi-node sensing, to improve the performance of sensing detection by the collaboration of multiple communication and sensing nodes.

An aspect of the disclosure is to provide a first communication and sensing node which transmits at least one sensing signal based on which the first communication and sensing node performs a first sensing measurement, and based on which a second sensing measurement is performed by a second communication and sensing node, such that sensing detection of a target object can be performed more accurately and the performance of the sensing detection can be improved when the results of the first and second sensing measurements are used for sensing detection of the same target object.

In accordance with an aspect of the disclosure, a method performed by a first communication and sensing node in a wireless communication system includes transmitting at least one sensing signal and performing a first sensing measurement based on the at least one sensing signal, wherein one or more of the at least one sensing signal is further used to perform a second sensing measurement by a second communication and sensing node.

In accordance with an aspect of the disclosure, a method performed by a second communication and sensing node in a wireless communication system includes receiving, from at least one first communication and sensing node, one or more of at least one sensing signal, wherein the at least one sensing signal is used to perform a first sensing measurement by the first communication and sensing node, and performing a second sensing measurement based on the at least one received sensing signal.

In accordance with an aspect of the disclosure, a first communication and sensing node in a wireless communication system includes a transceiver, and at least one processor, coupled to the transceiver and configured to transmit at least one sensing signal, and perform a first sensing measurement based on the at least one sensing signal, wherein one or more of the at least one sensing signal is further used to perform a second sensing measurement by a second communication and sensing node.

In accordance with an aspect of the disclosure, a second communication and sensing node in a wireless communication system includes a transceiver, and at least one processor, coupled to the transceiver and configured to receive, from at least one first communication and sensing node, one or more of at least one sensing signal, wherein the at least one sensing signal is used to perform a first sensing measurement by the first communication and sensing node, and perform a second sensing measurement based on the at least one received sensing signal.

### BRIEF DESCRIPTION OF THE DRAWINGS

The foregoing and other aspects, features and advantages of embodiments herein will become more apparent from the following description with reference to the accompanying drawings, in which:

FIG. 1 illustrates a wireless network 100 according to an embodiment;

FIG. 2A illustrates a wireless transmission path according to an embodiment;

FIG. 2B illustrates a wireless reception path according to an embodiment;

FIG. 3A illustrates a UE according to an embodiment;

FIG. 3B illustrates a gNB according to an embodiment;

FIG. 4 illustrates a method performed by a first communication and sensing node according to an embodiment;

FIG. 5 illustrates a method performed by a second communication and sensing node according to an embodiment;

FIG. 6 illustrates a method for sensing detection according to an embodiment;

FIG. 7 illustrates a method for sensing detection according to an embodiment;

FIG. 8 illustrates a block diagram of a first communication and sensing node according to an embodiment;

FIG. 9 illustrates a block diagram of a second communication and sensing node according to an embodiment;

FIG. 10 illustrates a block diagram of a device for sensing detection according to an embodiment.

FIG. 11 illustrates a method performed by a first terminal according to an embodiment;

FIG. 12 illustrates a method performed by a node according to an embodiment;

FIG. 13 illustrates an example of performing sensing detection of a target object according to an embodiment;

FIG. 14 illustrates a block diagram of a first terminal according to an embodiment; and

FIG. 15 illustrates a block diagram of a node according to an embodiment.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure.

Descriptions of well-known functions and constructions may be omitted for the sake of clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure.

It is to be understood that the singular forms a, an, and the include plural referents unless the context clearly dictates otherwise. Thus, reference to a component surface includes reference to one or more of such surfaces.

The terms include or may include refers to the existence of a corresponding disclosed function, operation or component which may be used herein and do not limit one or more additional functions, operations, or components. Terms such as include and/or have may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term or used herein includes any or all of combinations of listed words. For example, the expression A or B may include A, may include B, or may include both A and B.

In the disclosure,/may denote and, or, or and/or.

Unless defined differently, all terms used herein, which include technical terminologies or scientific terminologies, have the same meaning as that understood by a person skilled in the art to which the present disclosure pertains. Such terms as those defined in a generally used dictionary are to be interpreted to have the meanings equal to the contextual meanings in the relevant field of art and are not to be interpreted to have excessively formal meanings unless clearly defined herein.

Embodiments of the present disclosure are further described below in conjunction with the accompanying drawings. The text and drawings are provided as examples only to help readers understand the disclosure and are not intended and should not be interpreted as limiting the scope of the disclosure in any manner.

Embodiments of the disclosure may be applied to various communication scenarios, including, but not limited to, scenarios in which a base station communicates with a terminal, a base station communicates with another base station, or a terminal communicates with another terminal. The configuration of physical resources may include time domain resources and/or frequency domain resources. The time domain resources may include an orthogonal frequency division multiplexing (OFDM) symbol, a time slot, a micro time slot, or a subframe, etc., and the frequency domain resources may include a channel, a subchannel, a carrier, or a subcarrier, etc.

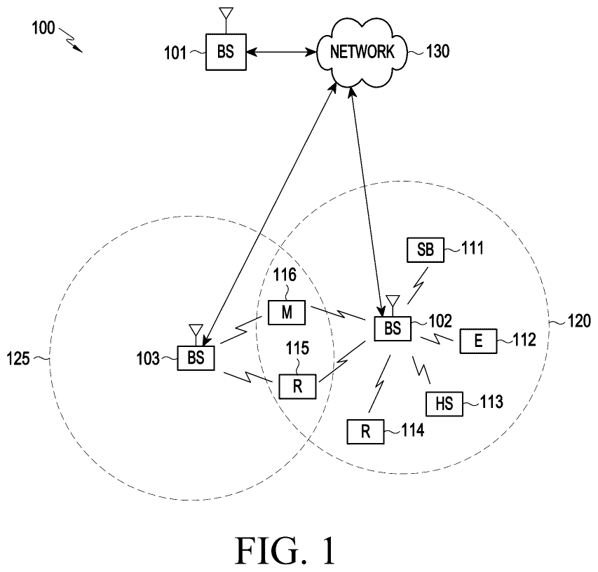

FIG. 1 illustrates a wireless network 100 according to an embodiment.

Referring to FIG. 1, the wireless network 100 includes a gNodeB (gNB) 101, a gNB 102, and a gNB 103, where gNB 101 communicates with gNB 102 and gNB and with at least one Internet protocol (IP) network 130, such as the Internet, a private IP network, or other data networks.

Depending on a type of the network, other well-known terms such as base station (BS) or access point may be used instead of gNodeB or gNB. For convenience, the terms gNodeB and gNB are used herein to refer to network infrastructure components that provide wireless access for remote terminals. Other well-known terms such as mobile station, user station, remote terminal, wireless terminal or user apparatus may be used instead of user equipment or UE. For convenience, user equipment (UE) are used herein to refer to remote wireless devices that wirelessly access the gNB, whether the UE is a mobile phone or a smart phone or a fixed device, such as a desktop computer or a vending machine.

The gNB 102 provides wireless broadband access to the network 130 for a first plurality of UEs within a coverage area 120 of gNB 102. The first plurality of UEs include a UE 111, which may be located in a small business (SB) 111, a UE which may be located in an enterprise (E) 112, a UE which may be located in a wireless fidelity (WiFi) hotspot (HS) 113, a UE which may be located in a first residence (R) 114, a UE which may be located in a second residence (R) 115, and a UE which may be a mobile device (M) 116, such as a cellular phone, a wireless laptop computer, or a wireless personal data assistant (PDA). The gNB 103 provides wireless broadband access to network 130 for a second plurality of UEs within a coverage area 125 of gNB 103. The second plurality of UEs include a UE in the 2nd R 115 and the UE (M) 116. One or more of gNBs 101-103 can communicate with each other and with UEs at 111-116 using 5G, LTE, LTE-advanced (LTE-A), WiMAX or other advanced wireless communication technologies.

The dashed lines show approximate ranges of the coverage areas 120 and 125, and the ranges are shown as approximate circles merely for illustration purposes. Thus, the coverage areas associated with the gNBs, such as the coverage areas 120 and 125, may have other shapes, including irregular shapes, depending on configurations of the gNBs and changes in the radio environment associated with natural and man-made obstacles.

One or more of gNB 101, gNB 102, and gNB 103 include a two-dimensional (2D) antenna array as described herein. One or more of gNB 101, gNB 102, and gNB 103 support codebook designs and structures for systems with 2D antenna arrays.

Although FIG. 1 illustrates an example of the wireless network 100, various changes may be made to FIG. 1. The wireless network 100 can include any number of gNBs and any number of UEs in any suitable arrangement, and gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

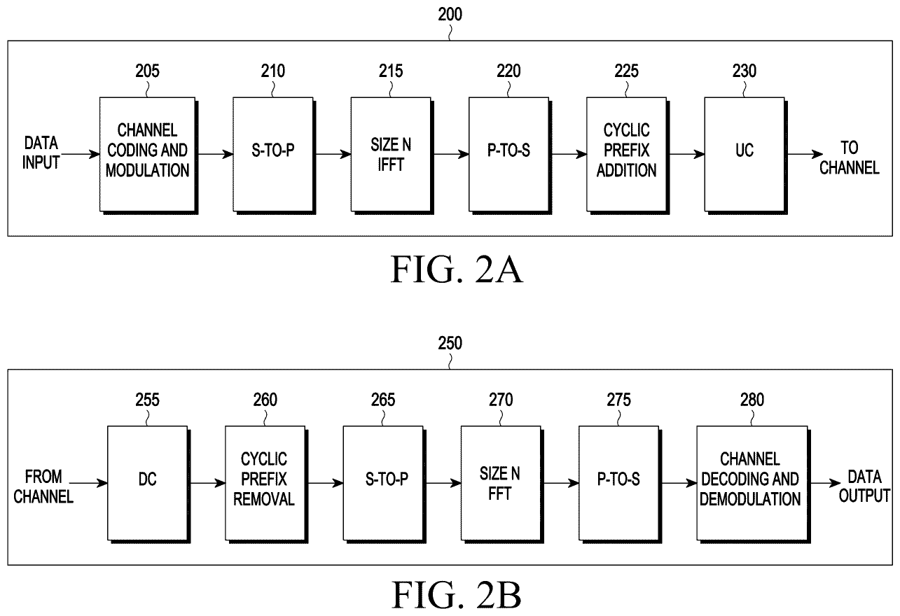

FIG. 2A illustrates a wireless transmission path according to an embodiment. FIG. 2B illustrates a wireless reception path according to an embodiment.

Referring to FIG. 2A, the transmission path 200 in FIG. 2A may be described as being implemented in a gNB, and the reception path 250 in FIG. 2B may be described as being implemented in a UE. However, the reception path 250 may be implemented in a gNB and the transmission path 200 may be implemented in a UE. Referring to FIG. 2B, the reception path 250 is configured to support codebook designs and structures for systems with 2D antenna arrays as described herein.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230.

The reception path 250 includes a down-converter (DC) 255, a cyclic prefix removal block 260, an S-to-P block 265, a size N fast Fourier transform (FFT) block 270, a P-to-S block 275, and a channel decoding and demodulation block 280.

In the transmission path 200, the channel coding and modulation block 205 receives a set of information bits, applies low density parity check (LDPC) coding, and modulates the input bits by using quadrature phase shift keying (QPSK) or quadrature amplitude modulation (QAM)) to generate a sequence of frequency-domain modulated symbols. The S-to-P block 210 demultiplexes serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The P-to-S block 220 multiplexes parallel time-domain output symbols from the size N IFFT block 215 to generate a serial time-domain signal. The cyclic prefix addition block 225 inserts a cyclic prefix into the time-domain signal. The up-converter 230 up-converts the output of the cyclic prefix addition block 225 to an RF frequency for transmission via a wireless channel. The signal can also be filtered at a baseband before switching to the RF frequency.

The RF signal transmitted from gNB 102 arrives at the UE 116 after passing through the wireless channel, and operations in reverse to those at gNB 102 are performed at the UE 116. The down-converter 255 down-converts the received signal to a baseband frequency, and the cyclic prefix removal block 260 removes the cyclic prefix to generate a serial time-domain baseband signal. The S-to-Pa block 265 converts the time-domain baseband signal into a parallel time-domain signal. The size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to the UEs at 111-116 in the downlink and may implement a reception path 250 similar to that for receiving from UEs at 111-116 in the uplink. Similarly, each of these UEs may implement a transmission path 200 for transmitting to gNBs 101-103 in the uplink, and may implement a reception path 250 for receiving from gNBs 101-103 in the downlink.

Each of the components in FIGS. 2A and 2B may be implemented using only hardware or using a combination of hardware and software/firmware. For example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Although described as using FFT and IFFT, this is only illustrative and should not be interpreted as limiting the scope of the present disclosure. Other types of transforms may be used, such as discrete Fourier transform (DFT) and inverse discrete Fourier transform (IDFT) functions. For the DFT and IDFT functions, the value of variable N may be any integer, such as 1, 2, 3, or 4, while for FFT and IFFT functions, the value of variable N may be any integer which is a power of 2, such as 1, 2, 4, 8, or 16.

Although FIGS. 2A and 2B illustrate examples of wireless transmission and reception paths, various changes may be made to FIGS. 2A and 2B. For example, various components in FIGS. 2A and 2B may be combined, further subdivided or omitted, and additional components may be added according to specific requirements. FIGS. 2A and 2B illustrate examples of types of transmission and reception paths that may be used in a wireless network. Any other suitable architecture may be used to support wireless communication in a wireless network.

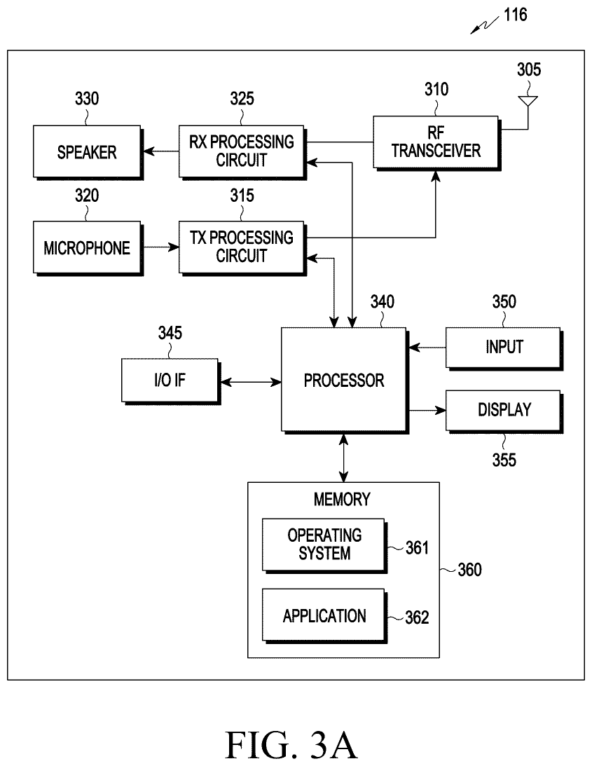

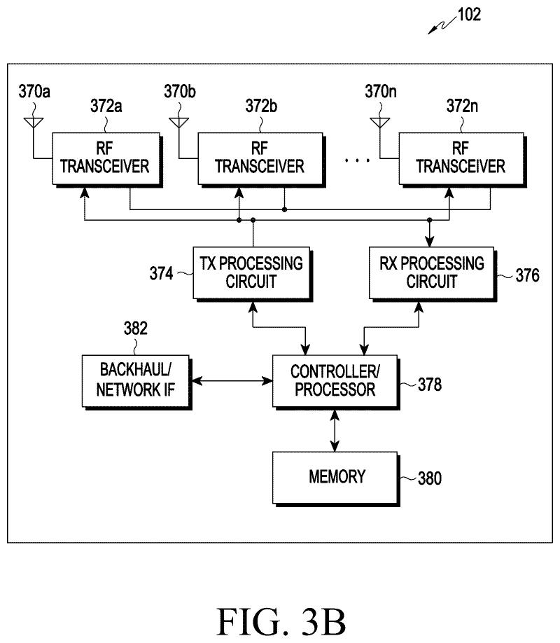

FIG. 3A illustrates a UE according to an embodiment.

Referring to FIG. 3A, the UE 116 includes an antenna 305, a radio frequency (RF) transceiver 310, a transmission (TX) processing circuit 315, a microphone 320, a reception (RX) processing circuit 325, a speaker 330, a processor/controller 340, an input/output (I/O) interface (IF) 345, an input device(s) 350, a display 355, and a memory 360 having an operating system (OS) 361 and one or more applications 362.

The RF transceiver 310 receives an incoming RF signal transmitted by a gNB of the wireless network 100 from the antenna 305 and down-converts the incoming RF signal to generate an intermediate frequency or baseband signal. The intermediate frequency or baseband signal is transmitted to the RX processing circuit 325, which generates a processed baseband signal by filtering, decoding and/or digitizing the baseband or intermediate frequency signal. The RX processing circuit 325 transmits the processed baseband signal to the speaker 330 for voice data or to the processor/controller 340 for web browsing data.

The TX processing circuit 315 receives analog or digital voice data from the microphone 320 or other outgoing network, email or interactive video game data from the processor/controller 340. The TX processing circuit 315 encodes, multiplexes, and/or digitizes the outgoing baseband data to generate a processed baseband or intermediate frequency signal. The RF transceiver 310 receives the outgoing processed baseband or intermediate frequency signal from the TX processing circuit 315 and up-converts the baseband or intermediate frequency signal into an RF signal transmitted via the antenna 305.

The processor/controller 340 can include one or more processors or other processing devices and execute an OS 361 stored in the memory 360 to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. The processor/controller 340 includes at least one microprocessor or microcontroller.

The processor/controller 340 is also capable of executing other processes and programs residing in the memory 360, such as operations for channel quality measurement and reporting for systems with 2D antenna arrays as described herein. The processor/controller 340 can move data into or out of the memory 360 as required by an execution process. The processor/controller 340 is configured to execute the application 362 based on the OS 361 or in response to signals received from the gNB or the operator. The processor/controller 340 is also coupled to an I/O interface 345 which provides the UE 116 with the ability to connect to other devices such as laptop computers and handheld computers. The I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or other display capable of presenting text and/or at least limited graphics from a website. The memory 360 is coupled to the processor/controller 340. A part of the memory 360 can include a random access memory (RAM), while another part of the memory 360 can include a flash memory or other read-only memory (ROM).

Although FIG. 3A illustrates an example of the UE 116, various changes may be made to FIG. 3A. For example, various components in FIG. 3A may be combined, further subdivided or omitted, and additional components may be added according to specific requirements. The processor/controller 340 may be divided into a plurality of processors, such as one or more central processing units (CPUs) and one or more graphics processing units (GPUs). Although FIG. 3A illustrates that the UE 116 is configured as a mobile phone or a smart phone, UEs may be configured to operate as other types of mobile or fixed devices.

FIG. 3B illustrates a gNB according to an embodiment.

Referring to FIG. 3B, the gNB 102 includes a plurality of antennas 370a-370n, a plurality of RF transceivers 372a-372n, a TX processing circuit 374, and an RX processing circuit 376. One or more of the plurality of antennas 370a-370n includes a 2D antenna array. The gNB 102 also includes a controller/processor 378, a memory 380, and a backhaul or network interface 382.

The RF transceivers 372a-372n receive an incoming RF signal from antennas 370a-370n, such as a signal transmitted by UEs or other gNBs, and down-convert the incoming RF signal to generate an intermediate frequency or baseband signal which is transmitted to the RX processing circuit 376, where the RX processing circuit 376 generates a processed baseband signal by filtering, decoding and/or digitizing the baseband or intermediate frequency signal. The RX processing circuit 376 transmits the processed baseband signal to the controller/processor 378 for further processing.

The TX processing circuit 374 receives analog or digital data, such as voice, network, email or interactive video game data, from the controller/processor 378 and encodes, multiplexes and/or digitizes outgoing baseband data to generate a processed baseband or intermediate frequency signal. The RF transceivers 372a-372n receive the outgoing processed baseband or intermediate frequency signal from the TX processing circuit 374 and up-convert the baseband or intermediate frequency signal into an RF signal transmitted via the antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. The controller/processor 378 may support any of a variety of other functions in gNB 102 and includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described herein. The controller/processor 378 supports communication between entities such as web real-time communications (RTCs). The controller/processor 378 can move data into or out of the memory 380 as required by an execution process.

The controller/processor 378 is also coupled to the backhaul or network IF 382 which enables the gNB 102 to communicate with other devices or systems through a backhaul connection or through a network. The backhaul or network IF 382 can support communication over any suitable wired or wireless connection(s). For example, when the gNB 102 is implemented as a part of a cellular communication system, such as a cellular communication system supporting 5G or new radio access technology or NR, long term evolution (LTE) or LTE-advanced (A), the backhaul or network IF 382 can enable the gNB 102 to communicate with other gNBs through wired or wireless backhaul connections. When the gNB 102 is implemented as an access point, the backhaul or network IF 382 can enable the gNB 102 to communicate with a larger network, such as the Internet, through a wired or wireless local area network or through a wired or wireless connection. The backhaul or network IF 382 includes any suitable structure that supports communication through a wired or wireless connection, such as an Ethernet or an RF transceiver.

The memory 380 is coupled to the controller/processor 378. A part of the memory 380 can include a random access memory (RAM), while another part of the memory 380 can include a flash memory or other read-only memories (ROMs). A plurality of instructions, such as the BIS algorithm, are stored in the memory and are configured to cause the controller/processor 378 to execute the BIS process and decode the received signal after subtracting at least one interference signal determined by the BIS algorithm.

The transmission and reception paths of the gNB 102 (implemented using the RF transceivers 372a-372n, TX processing circuit 374 and/or RX processing circuit 376) support aggregated communication with frequency division duplex (FDD) and time division duplex (TDD) cells.

Although FIG. 3B illustrates an example of a gNB 102, various changes may be made to FIG. 3B. For example, the gNB 102 can include any number of each component shown in FIG. 3A, the access point can include many backhaul or network IFs 382, and the controller/processor 378 can support routing functions to route data between different network addresses. Although illustrated as including a single instance of the TX processing circuit 374 and a single instance of the RX processing circuit 376, the gNB 102 can include multiple instances of each for each RF transceiver.

In the disclosure, at least a method performed by a first communication and sensing node, a method performed by a second communication and sensing node, and a method performed by an entity other than the first communication and sensing node and the second communication and sensing node are provided.

Specifically, at least a method performed by a first terminal, a method performed by a node, and a method performed by an entity other than the first terminal and the node are provided according to the disclosure.

A signal waveform used in the most widely used communication systems today is an OFDM modulation-based waveform. Studies have shown that a communication signal based on the OFDM waveform may achieve better performance as a sensing signal. Therefore, it is a feasible solution to consider adding the sensing function to the existing communication system to achieve the communication and sensing integration. A feasible solution of adding the sensing function to the existing communication system is to enable a receiver of a communication and sensing integration node (hereinafter, a communication and sensing node) support echo detection of a sensing signal, i.e., echo signal detection, wherein the echo signal refers to a signal that is reflected back to the receiver of the communication and sensing node by a surface of a target object after a sensing signal sent by the communication and sensing node reaches the target object. The target object may be accessed to a communication network (e.g., a base station, a terminal, etc.) or may not be accessed to a communication network (e.g., a small unmanned aerial vehicle (UAV), a building, an animal, a plant, etc.). Based on the echo signal and a baseband signal of the transmitted sensing signal, the communication and sensing node may estimate the number of target objects, a distance between the target object and the communication and sensing node, radial velocity of the target object, etc. For example, the communication and sensing node may estimate a propagation channel through which the sensing signal undergoes reflection from the target object and reaches the receiver of the sensing node, and a multipath delay of the propagation channel corresponding to the distance between the target object and the communication and sensing node.

The sensing detection may include sensing localization of a target object. Achieving the sensing localization of the target object requires obtaining not only the distance between the target object and the communication and sensing node, but also an direction angle of the target object.

A possible solution for obtaining the direction angle of the target object is that when the communication and sensing node is equipped with a large-scale antenna array, a plurality of sensing signals can be transmitted using different transmitting beams (also referred to as transmitting spatial filters), and the target object is identified in the echo detection of the sensing signal of any one of the transmitting beams, and the direction angle of the target object is the direction angle corresponding to that transmitting beam. The direction angle obtained by this scheme has an angular resolution of a width of the transmitting beam. There are other schemes to further improve the sensing resolution of the direction angle, such as a super-resolution algorithm having a performance advantage or disadvantage relative to the antenna size. In general, to improve the sensing performance of the direction angle, it is necessary to increase the antenna size of the communication and sensing node by increasing the number of array elements. Considering the limitation of equipment cost and energy consumption, however, it may not be feasible to improve the sensing detection performance of the direction angle by increasing the antenna size. In addition, when the communication and sensing node does not have the condition of a large-scale antenna array, such as when the central frequency point of the working band is below 6 GHZ, how to sense the direction angle of the target object is an urgent problem in improving the sensing detection performance.

According to the concept of multi-node sensing disclosed herein, the performance of sensing detection can be improved by the sensing resolution of the direction angle being improved. The concept also involves a sensing measurement and reporting method of the communication and sensing node, a signaling interaction process between the communication and sensing nodes, a signaling interaction through multiple communication and sensing nodes (e.g., primary and secondary communication and sensing nodes), and a fusion of sensing results of different communication and sensing nodes for the same target object based on a measurement and reporting mechanism of the sensing signal. Thus, the sensing detection performance can be improved by more accurate sensing and positioning of the target object being obtained.

Based on the multi-node sensing disclosed herein, the performance of sensing detection can be improved since the sensing resolution of the direction angle is improved. For example, this sensing may involve a signaling interaction process for communication and sensing, a measurement and reporting mechanism based on a sensing signal, etc.

A terminal may be configured to perform a sensing measurement by receiving signaling for assisting a node (another terminal or a network node (e.g., a base station, IAB, etc.)) in sensing, or by requesting another node to assist in sensing by transmitting signaling, thereby improving the sensing detection performance of a single communication and sensing node or improving the efficiency of resource usage of the sensing signal, etc. The method may involve a design of sensing related uplink/downlink/sidelink control information, or a request assistance sensing process of a terminal. Some embodiments can achieve a fusion of sensing results of different communication and sensing nodes for the same target object, thereby improving the sensing detection performance since accurate sensing and positioning of the target object is obtained.

The sensing signal herein may include an uplink sensing signal and/or a downlink sensing signal, wherein the uplink sensing signal includes at least one of an uplink sensing dedicated signal, an uplink shared channel, an uplink control channel, a channel sounding reference signal (SRS), a physical random access channel (PRACH), a demodulation reference signal of an uplink shared channel, a demodulation reference signal of an uplink control channel, etc. The downlink sensing signal includes at least one of a downlink sensing dedicated signal, a downlink shared channel, a downlink control channel, a channel state information reference signal (CSI-RS), a positioning reference signal (PRS), a synchronization signal, a broadcast channel (e.g. a physical broadcast channel (PBCH)), a synchronization signal block (SSB), a demodulation reference signal of a downlink shared channel, a demodulation reference signal of a downlink control channel, etc. The uplink or downlink sensing dedicated signal is an uplink or downlink physical signal and/or channel used for sensing purposes. A sidelink sensing signal at least includes one of a sidelink sensing dedicated signal, or a SideLink PRS (SL PRS).

Herein, a communication and sensing node that transmits the sensing signal may include a terminal or a base station. The base station as the communication and sensing node transmits a downlink physical channel and/or a downlink sensing signal and a terminal as a communication target object receives or does not receive the downlink physical channel and/or the downlink sensing signal. The terminal as the communication and sensing node transmits an uplink sensing signal, and a base station as the communication target object receives or does not receive the uplink physical channel or signal. The terminal as the communication and sensing node transmits an uplink sensing signal and another terminal as the communication target object receives or does not receive the uplink sensing signal.

In a multi-point sensing method disclosed herein, at least a first communication and sensing node and a second communication and sensing node are involved.

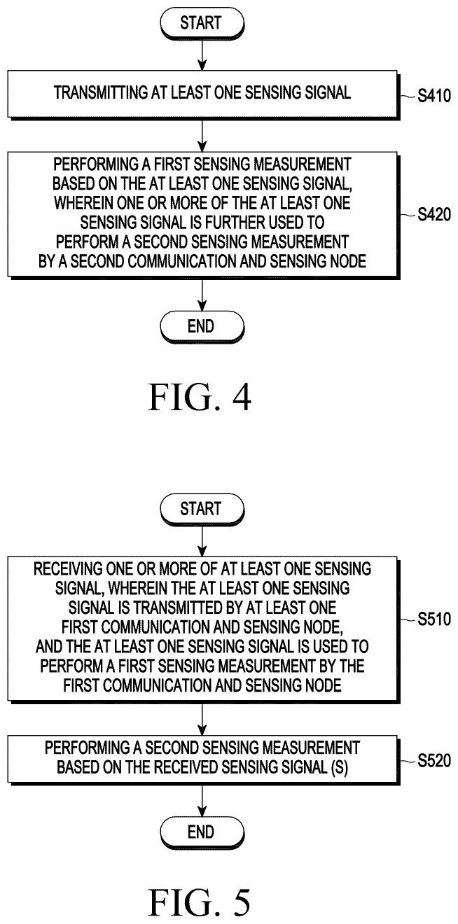

FIG. 4 illustrates a method performed by a first communication and sensing node according to an embodiment.

Referring to FIG. 4, at step S410, the first communication and sensing node transmits at least one sensing signal. At step S420, the first communication and sensing node performs a first sensing measurement based on the at least one sensing signal.

One or more of the at least one sensing signal is further used to perform a second sensing measurement by a second communication and sensing node. Since one or more of the sensing signal(s) sent by the first communication and sensing node is/are performed the sensing measurements by the first communication and sensing node and the second communication and sensing node, it is possible to perform sensing detection of a target object more accurately and improve the performance of sensing detection when both a result of the first sensing measurement and a result of the second sensing measurement are used for sensing detection of the same target object.

In the disclosure, both the first communication and sensing node and the second communication and sensing node may be one or more communication and sensing node, and, the first communication and sensing node and the second communication and sensing node may be the same device type or different device types. For example, the first communication and sensing node and the second communication and sensing node are both base stations or are both terminals, or one of these two sensing nodes is a base station and another is a terminal.

The first communication and sensing node has a self-sensing capability, wherein the self-sensing capability is that the first communication and sensing node may perform sensing-related detection based on a sensing signal the node sends by receiving an echo signal of a sensing signal the node sends. The first communication and sensing node may report a result of the first sensing measurement. Thus, step S420 may further include reporting a result of the first sensing measurement to at least one object, wherein the result of the first sensing measurement includes information related to the first sensing measurement. For example, the first communication and sensing node may itself perform the first sensing measurement based on the sensing signal transmitted by itself and report the result of the first sensing measurement to another object so that the another object may use the result of the first sensing measurement for sensing detection, e.g., the another object may perform sensing detection of the target object based on the result of the first sensing measurement from the first communication and sensing node and the result of the second sensing measurement from the second communication and sensing node.

The first communication and sensing node performing a first sensing measurement based on the at least one sensing signal may include receiving an echo signal of the at least one sensing signal and performing the first sensing measurement based on the echo signal.

The at least one object may include at least one of: at least one second communication and sensing node, a base station, a core network, a central processor, an LTE positioning protocol (LPP) server, a location management function (LMF) entity located in the core network or in a radio access network, a sensing function (SF) entity located in the core network or in the radio access network, but not limited thereto.

The method shown in FIG. 4 may further include receiving a result of the second sensing measurement from the second communication and sensing node, wherein the result of the second sensing measurement includes information related to the second sensing measurement. The result of the first sensing measurement and the result of the second sensing measurement may be used to perform sensing detection of the target object. The accuracy of sensing detection can be improved when the sensing measurement results from different communication and sensing nodes are used to perform sensing detection of the same target object. For example, the first communication and sensing node may itself perform sensing detection of the target object based on the result of the first sensing measurement and the result of the second sensing measurement from the second communication and sensing node. Thus, the method shown in FIG. 4 may further include: performing sensing detection of the target object based on the result of the first sensing measurement and the result of the second sensing measurement.

The result of the first sensing measurement may include at least one of a first time related measurement result, wherein the first time related measurement result includes a time or a time delay, or a relative time or a relative time delay, of each of at least one path, wherein the at least one path is detected by the first communication and sensing node performing the first sensing measurement based on the at least one sensing signal, a first power related measurement result, wherein the first power related measurement result includes a power or a power average of channel response at each of the at least one path, measurement information obtained based on the first time related measurement result. the measurement information obtained based on the first time related measurement result may include, but is not limited to, distance information between the first communication and sensing node and the target object obtained by the first communication and sensing node based on the first time related measurement result.

The result of the first sensing measurement at least includes a time delay or a relative time delay of at least one of a plurality of paths detected by the first communication and sensing node performing the first sensing measurement based on the at least one sensing signal. Thus, the at least one of the plurality of paths detected by the first communication and sensing node performing the first sensing measurement based on the at least one sensing signal is a channel component formed by undergoing a reflection from a certain target object, i.e. the time delay or the relative time delay of the at least one of the plurality of paths corresponds to a sum of a two-way distance from the first communication and sensing node to the certain target object.

The first time related measurement result may include at least one of a time related measurement result of a first strongest path with the highest power or average power of channel response among a plurality of paths detected by the first communication and sensing node performing the first sensing measurement based on the at least one sensing signal, a time related measurement result of a first path detected first in time by the first communication and sensing node performing the first sensing measurement based on the at least one sensing signal, and a plurality of time related measurement results of a first plurality of specific paths of the plurality of paths satisfying at least one condition. The at least one condition may include at least one of a power or an average power of channel response exceeding a fourth threshold, the time related measurement result being greater than or equal to a fifth threshold, or the time related measurement result being less than or equal to a sixth threshold. For example, the result of the first sensing measurement may include a time delay or a relative time delay of a first strongest path detected by the first communication and sensing node performing the first sensing measurement based on the at least one sensing signal, wherein the at least one sensing signal is transmitted by the first communication and sensing node. The first strongest path refers to a path with the highest power or average power of channel response among all detected plurality of paths. The advantage of using the first strongest path as a measurement result of sensing detection is that the first communication and sensing node detects only the strongest scattering target object in the environment, and the processes of both measurement and reporting are simpler and may be applied to scenarios that are more sensitive to the presence or absence of the target object, e.g., anti-intrusion sensing.

An example of the relative time delay may be that the result of the first sensing measurement includes a relative time difference between a time T′_{Rx,spath} (T′_{Rx,spath} (a signal reception time on that path) of the first strongest path and a start time T_{Tx,start} of a subframe/OFDM symbol of the first communication and sensing node for transmitting the sensing signal, that is, T′_{Rx,spath}−T_{Tx,start}. When the first communication and sensing node is a terminal, T_{Tx,start} is a start time of an uplink subframe/uplink OFDM symbol of the first communication and sensing node for transmitting the sensing signal. When the first communication and sensing node is a base station, T_{Tx,start} is a start time of a downlink subframe/downlink OFDM symbol of the first communication and sensing node for transmitting the sensing signal. The above examples of the relative time delay may be used in the same manner for subsequent implementations of other results of the first sensing measurement. Therefore, the examples corresponding to the relative time are not detailed separately in the following description of other implementations.

For example, the result of the first sensing measurement may include a time delay or a relative time delay of a first path detected by the first communication and sensing node performing the first sensing measurement based on the at least one sensing signal, wherein the at least one sensing signal is sent by the first communication and sensing node. The advantage of using the first path as a measurement result of sensing detection is that the first communication and sensing node detects only the nearest scattering target object in the environment, and the processes of both measurement and reporting are simpler and may be applied to sensing scenarios where the identification of the nearest sensing target is more demanding, such as autonomous driving.

For example, the result of the first sensing measurement may include a plurality of time delays or a plurality of relative time delays of a first plurality of specific paths detected by the first communication and sensing node performing the first sensing measurement based on the at least one sensing signal, wherein the at least one sensing signal is sent by the first communication and sensing node. In some examples of this implementation, the first plurality of specific paths may refer to a plurality of paths where a power or an average power of channel response exceeds a fourth threshold, wherein the fourth threshold may be a value predetermined or obtained by the first communication and sensing node acquiring configuration information. By this method, the first communication and sensing node determines whether the detected path (hereinafter, detection path) corresponds to the target object by the fourth threshold. When the power or the average power of channel response of the detection path is greater than the fourth threshold, this indicates that the detection path is more likely to correspond to a real target object, which prevents false detection due to clutter and other environmental factors.

The first plurality of specific paths may refer to detection paths with a time delay or a relative time delay greater than or equal to a fifth threshold, and/or, detection paths with a time delay or a relative time delay less than or equal to a sixth threshold. The fifth threshold or the sixth threshold may be a protocol predetermined or obtained by the first communication and sensing node according to configuration information. By this method, the first communication and sensing node detects only a target object within a certain distance range in the environment, such as a range of [d₁, d₂] from the first communication and sensing node, thereby simplifying the processes of measurement and reporting, and may be applicable to sensing scenarios where there is a limit on the distance range of the sensing target, such as indoor sensing.

The first plurality of detection paths may be where a power or an average power of channel response detected by the first communication and sensing node exceeds a fourth threshold, where a time delay or a relative time delay is greater than or equal to a fifth threshold, and where a time delay or a relative time delay is less than or equal to a sixth threshold.

The result of the first sensing measurement further includes at least one of identification information or index information of the first communication and sensing node, related information of a transmitting beam used by the first communication and sensing node to transmit the at least one sensing signal, and indication information indicating that a valid sensing measurement result is not obtained.

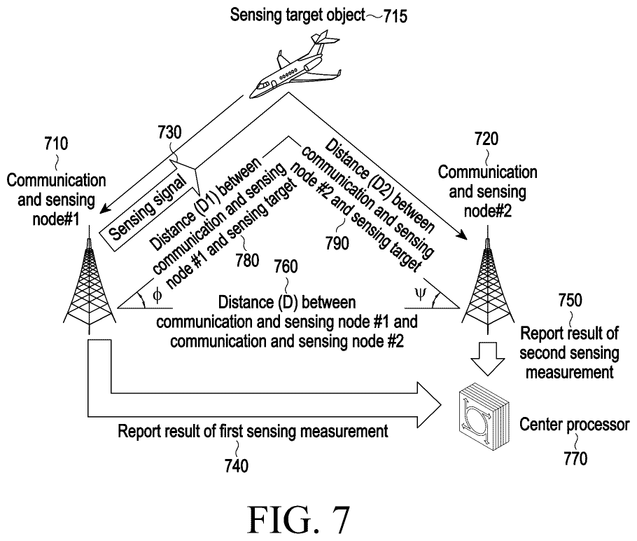

For example, the result of the first sensing measurement may also include related information of a transmitting beam used by the first communication and sensing node to transmit the at least one sensing signal, e.g., an index of the transmitting beam, a direction of the transmitting beam, etc. By this method, the beam direction of the sensing signal sent by the first communication and sensing node may be used as broad information about an direction angle Φ of the target object in FIG. 7 to be described below.

When the result of the second sensing measurement includes time delay related measurement information for a plurality of detection paths, the SF may determine, based on the transmitting beam direction of the first communication and sensing node, an invalid result of the plurality of detection paths included in the result of the second sensing measurement which does not correspond to the target object. For example, when the SF calculates the direction angle Φ′ of the target object based on the time delay related measurement information of a certain detection path in the result of the second sensing measurement, if Φ′ deviates too far from the beam direction of the sensing signal sent by the first communication and sensing node, this may indicate that the measurement result of the detection path is invalid.

The result of the first sensing measurement and the result of the second sensing measurement may be used to perform sensing detection of the target object by calculating the direction angle of the target object to the first communication and sensing node, and/or the direction angle of the target object to the second communication and sensing node. Since the results of the sensing measurements from different communication and sensing nodes are used to calculate the direction angle, the accuracy of the sensing localization of the target object may be improved. For example, the first communication and sensing node may receive the result of the second sensing measurement from the second communication and sensing node and calculate an direction angle of the target object to the first communication and sensing node, and/or an direction angle of the target object to the second communication and sensing node, based on the result of the first sensing measurement and the result of the second sensing measurement. The result of the first sensing measurement may include distance information between the first communication and sensing node and the target object obtained by the first communication and sensing node based on the first time related measurement result, and the result of the second sensing measurement may include a sum of a first distance between the first communication and sensing node and the target object and a second distance between the second communication and sensing node and the target object obtained by the second communication and sensing node performing the second sensing measurement. The first communication and sensing node may calculate the direction angle from the target object to the first communication and sensing node, and/or the direction angle from the target object to the second communication and sensing node, based on the obtained distance information and the distance information from the second communication and sensing node.

FIG. 5 illustrates a method performed by a second communication and sensing node according to an embodiment.

Referring to FIG. 5, at step S510, the second communication and sensing node receives one or more of at least one sensing signal, wherein the at least one sensing signal is transmitted by at least one first communication and sensing node, and the at least one sensing signal is used to perform a first sensing measurement by the first communication and sensing node.

Step S510 may further include obtaining configuration information related to the at least one sensing signal, and receiving one or more of the at least one sensing signal according to the obtained configuration information. Obtaining configuration information related to the at least one sensing signal may indicate that the second communication and sensing node obtains related configuration of the at least one sensing signal from a third entity including at least one of a positioning server, an LMF, a core network, a central processor, an SF, at least one first communication and sensing node, a base station, and a terminal. Specifically, when the second communication and sensing node is a base station, the second communication and sensing node obtains the configuration information related to the sensing signal sent from the core network/LMF/SF/CPU/first communication and sensing node/another base station. When the second communication and sensing node is a terminal, the second communication and sensing node obtains the configuration information related to the sensing signal sent from the base station/first communication and sensing node. For example, when the second communication and sensing node is a terminal and the first communication and sensing node is a base station, the second communication and sensing node obtains the configuration information related to the sensing signal sent from the first communication and sensing node, where the configuration information may be configured by downlink control information or high-level signaling or media access control (MAC) signaling.

When both the second communication and sensing node and the first communication and sensing node are terminals, the second communication and sensing node obtains the configuration information related to the sensing signal sent from the first communication and sensing node, where the configuration information may be configured by a bypass control channel/bypass shared channel. When both the second communication and sensing node and the first communication and sensing node are terminals, the second communication and sensing node obtains the configuration information related to the sensing signal sent from a base station, where the configuration information may be configured by downlink control information or high-level signaling or MAC signaling.

The configuration information may also include at least one of a time domain resource for transmitting the sensing signal, a frequency domain resource for transmitting the sensing signal, a sequence used for transmitting the sensing signal, an identification code or index information of a node that transmits the sensing signal, and the number of repetitions of the sensing signal. The time domain resource of the sensing signal may refer to at least one of a time domain symbol, a time slot, a subframe, and a wireless frame in which the sensing signal is sent.

Configuration information for configuring the time domain resource of the sensing signal may include at least one of a transmission period of the sensing signal, a start time/termination time at which the sensing signal is sent, a duration for which the sensing signal is sent, and an OFDM symbol position of the sensing signal within a period/time slot/subframe. The frequency domain resource of the sensing signal may refer to at least one of a carrier in which the sensing signal is sent, a BWP, a sub-band, a physical resource block group (RBG), or a physical resource block (PRB).

Configuration information for configuring the frequency domain resource of the sensing signal may include at least one of location(s)/index(es) of one or more PRBs, RBs, or RB sets to which the sensing signal is assigned, a BWP/subband/carrier where a PRB, an RB, or an RB set to which the sensing signal is assigned, a relative position/index in a BWP/subband/carrier where a PRB or a RB or a RB set to which the sensing signal is assigned is located, and frequency hopping configuration of the sensing signal.

The sensing signal may be configured for repetitions in the time domain. Specifically, the related configuration of the sensing signal includes the number of times the sensing signal is repeated, and the sensing signal repeatedly sent may be sent by the first communication and sensing node using the same transmitting beam. Then, the sensing signal repeatedly sent may be used in the scanning process of a received beam of the second communication and sensing node to facilitate the second communication and sensing node to find a suitable received beam for receiving the sensing signal.

Alternatively, the second communication and sensing node may receive the repeatedly sent sensing signal with the same received beam, and the received repeated sensing signal may be combined or averaged to improve the accuracy of the sensing related measurement. The related configuration of the sensing signal may also include an identification code/index of the first communication and sensing node.

When the second communication and sensing node is configured to receive a plurality of sensing signals, each of acquired configuration information of the plurality of sensing signals may include an identification code/index of the first communication and sensing node that sent the sensing signal for the second communication and sensing node to distinguish a source of each of the sensing signals and a sequence of acquiring the sensing signal.

Each of the configuration information of the plurality of sensing signals may include, in addition to the identification code/index of the first communication and sensing node, indication information of respective time domain resources of the sensing signals, respective frequency domain resources of the sensing signals, and the number of repetitions of the sensing signal. This method considers that sensing environments between the second communication and sensing node and different first communication and sensing nodes are different. As such, different sensing signal configurations may be required to support different sensing environments.

Obtaining the configuration information related to the at least one sensing signal may include obtaining identification or index information of the first communication and sensing node and determining at least one of the time domain resource, the frequency domain resource, and the used sequence based on the obtained identification information or index information of the first communication and sensing node. For example, the second communication and sensing node may determine at least one of the time domain resource, the frequency domain resource, and the used sequence for the first communication and sensing node transmitting the sensing signal based on the identification code or index of the first communication and sensing node, to determine that the time domain resource and/or the frequency domain resource and/or the sequence for the first communication and sensing node transmitting the sensing signal is (n+1) th of N predetermined resources according to a remainder n the identification code or index of the first communication and sensing node divided by a fixed value N. By this method, the signaling of the time domain and/or frequency domain resource configuration of the sensing signal may be saved.

In addition, when the second communication and sensing node needs to assist multiple first communication and sensing nodes in sensing, the sensing signals from different first communication and sensing nodes may be designed as time division or frequency division or code division (e.g., N predetermined resources), thereby ensuring that the sensing signals from different first communication and sensing nodes are orthogonal or quasi-orthogonal. Thus, the performance of the second communication and sensing node assisting in the sensing is ensured.

At step S520, the second communication and sensing node may perform a second sensing measurement based on the received sensing signal(s). For example, the second communication and sensing node receives signal(s) after one or more of the at least one sensing signal are reflected back by the target object and performs the second sensing measurement based on the received signal(s).

Since one or more of the sensing signal(s) sent by the first communication and sensing node will be used by both the first communication and sensing node and the second communication and sensing node to perform the sensing measurements, sensing detection of the target object can be performed more accurately and the performance of sensing detection can be improved when both the result of the first sensing measurement and the result of the second sensing measurement are used for sensing detection of the same target object.

The method in FIG. 5 may further include that a second communication and sensing node reports a result of the second sensing measurement to at least one object, wherein the result of the second sensing measurement includes information related to the second sensing measurement. The at least one object may include at least one of: at least one first communication and sensing node, a base station, a core network, a central processor, a location server (e.g., an LTE positioning protocol (LPP) server, etc.), a location management function (LMF) entity located in the core network or in a wireless access network, a sensing function (SF) entity located in the core network, or may be a local sensing function entity located in the wireless access network, but the disclosure is not limited thereto.

The result of the first sensing measurement and the result of the second sensing measurement may be used to perform sensing detection of the target object. The accuracy of sensing detection can be improved when the results of the sensing measurements from different communication and sensing nodes are used to perform sensing detection of the same target object. The second communication and sensing node may perform sensing detection of the target object based on the result of the second sensing measurement and the result of the first sensing measurement from the first communication and sensing node. Thus, the method in FIG. 5 may further include receiving the result of the first sensing measurement from the first communication and sensing node, wherein the result of the first sensing measurement includes information related to the first sensing measurement, and performing sensing detection of the target object based on the result of the first sensing measurement and the result of the second sensing measurement. The result of the first sensing measurement has been described above in the description with reference to FIG. 4 and will not be repeated here.

The result of the first sensing measurement and the result of the second sensing measurement may be used to perform sensing detection of the target object, by being used to calculate an direction angle of the target object to the first communication and sensing node, and/or an direction angle of the target object to the second communication and sensing node. Since the results of the sensing measurements from different communication and sensing nodes are used to calculate the direction angle, the accuracy of the sensing localization for the target object can be improved. The second communication and sensing node may calculate an direction angle from the target object to the first communication and sensing node, and/or an direction angle from the target object to the second communication and sensing node, based on the result of the first sensing measurement and the result of the second sensing measurement. For example, the result of the first sensing measurement may include distance information between the first communication and sensing node and the target object obtained by the first communication and sensing node performing the first sensing measurement.

The result of the second sensing measurement may include a sum of a first distance between the first communication and sensing node and the target object and a second distance between the second communication and sensing node and the target object obtained by the second communication and sensing node performing the second sensing measurement. The second communication and sensing node may calculate the direction angle from the target object to the first communication and sensing node, and/or the direction angle from the target object to the second communication and sensing node, based on the distance information obtained by itself and the distance information from the first communication and sensing node.

The result of the second sensing measurement includes at least one of a second time related measurement result including a time or a time delay, or a relative time or a relative time delay, of each of at least one path detected by the second communication and sensing node performing the second sensing measurement based on received sensing signal(s), measurement information obtained based on the second time related measurement result, or a second power related measurement result including a power or a power average of channel response at each of the at least one path. The measurement information obtained based on the second time related measurement result may include a sum of a first distance between the first communication and sensing node and the target object and a second distance between the second communication and sensing node and the target object obtained by the second communication and sensing node based on the second time related measurement result.

The result of the second sensing measurement at least includes a time delay or a relative time delay of at least one of a plurality of paths detected by the second communication and sensing node performing the second sensing measurement based on the received sensing signal(s). Based on this method, on the premise that the second communication and sensing node may detect the target object, at least one of the plurality of paths detected by the second communication and sensing node performing the second sensing measurement based on the received sensing signal(s) is a channel component formed by undergoing a reflection from a certain target object. That is, the time delay or relative time delay of the at least one of the plurality of paths corresponds to a sum of two distances from the first communication and sensing node to the target object and from the target object to the second communication and sensing node.

The result of the second sensing measurement at least includes a power or a power average of channel response at each of the at least one of the plurality of paths detected by the second communication and sensing node performing the second sensing measurement based on the received sensing signal(s). Based on this method, when the second communication and sensing node reports time related measurement results for multiple paths, or when there is a plurality of second communication and sensing nodes reporting time related measurements for different detection paths, if the power related measurement for each path is reported at the same time, the reported object (e.g., a SF, etc.) is enabled to perform a filtering of the measurement results by sorting based on the power values of channel response, the target object is calculated according to the delays or the relative delays of the top N detected paths with the highest power value, where N is a predetermined value.

The second time related measurement result may include at least one of a time related measurement result of a second strongest path with the highest power or average power of channel response among a plurality of paths detected by the second communication and sensing node performing the second sensing measurement based on the received sensing signal(s), a time related measurement result of a first detected path in time by the second communication and sensing node performing the second sensing measurement based on the received sensing signal(s), and a plurality of time related measurement results of a second plurality of paths satisfying at least one condition. For example, the at least one condition includes at least one of a power or an average power of channel response exceeding a first threshold, the time related measurement result being greater than or equal to a second threshold, or the time related measurement result being less than or equal to a third threshold.

The result of the second sensing measurement may include a time delay or a relative time delay of a second strongest path detected by the second communication and sensing node performing the second sensing measurement based on the received sensing signal(s). The second strongest path refers to a path with the highest power or average power of channel response among all detected plurality of paths. Using the second strongest path as a measurement result of sensing detection enables the second communication and sensing node to detect only the strongest scattering target object in the environment, simplifies the processes of both measurement and reporting, and may be applied to scenarios that are more sensitive to the presence or absence of the target object, e.g., anti-intrusion sensing.

An example of the relative time delay may be a relative time difference between a time T_{Rx,spath} (T_{Rx,spath} is a signal reception time on that path) of the second strongest path and a start time T_{Rxstart} of a subframe/OFDM symbol of the second communication and sensing node for receiving the sensing signal(s), that is, T_{Rx,spath}−T_{Rx,start}. When the second communication and sensing node is a terminal, T_{Rx,start} is a start time of an downlink subframe/downlink OFDM symbol of the second communication and sensing node for receiving the sensing signal(s). When the second communication and sensing node is a base station, T_{Rx,start} is a start time of an uplink subframe/uplink OFDM symbol of the second communication and sensing node for receiving the sensing signal(s). The above examples of the relative time may be used in the same manner for subsequent implementations of other results of the second sensing measurement. Therefore, the examples corresponding to the relative time are not detailed separately in the following description of other implementations.

The result of the second sensing measurement may include a time delay or a relative time delay of a first path detected by the second communication and sensing node performing the second sensing measurement based on the received sensing signal(s). By using the first path as a measurement result of sensing detection, the second communication and sensing node detects only the nearest scattering target object in the environment, thus simplifying the processes of both measurement and reporting and may be applied to sensing scenarios where the identification of the nearest sensing target is more demanding, such as autonomous driving.

The result of the second sensing measurement may include a plurality of time delays or a plurality of relative time delays of a second plurality of paths detected by the second communication and sensing node performing the second sensing measurement based on the received sensing signal(s). The second plurality of paths may refer to where a power or an average power of channel response exceeds a first threshold indicating a value predetermined or obtained by the second communication and sensing node acquiring configuration information. By this method, the second communication and sensing node determines whether the detection path corresponds to the target object by the first threshold. When the power or the average power of channel response of the detection path is greater than the first threshold, this indicates that it is more likely to correspond to a real target object, avoiding false detection due to clutter and other environmental factors.

The second plurality of paths may refer to detection paths with a time delay or a relative time delay greater than or equal to a second threshold obtained by the second communication and sensing node through measurement or by the second communication and sensing node through configuration information. For example, the second communication and sensing node obtains the configuration information of the second threshold.

Alternatively, the second communication and sensing node obtains indication information of a distance between the first communication and sensing node and the second communication and sensing node, and calculates the second threshold based on the distance, such

$$as η = \frac{D}{c} ,$$

where η denotes the second threshold, D denotes the distance between the first communication and sensing node and the second communication and sensing node, and c denotes the speed of light. When the second communication and sensing node is a terminal and the first communication and sensing node is a base station, the second communication and sensing node obtains uplink transmission timing advance and calculates the second threshold based on the uplink transmission timing advance, such as

$$η = \frac{{N}_{T A}}{2} ,$$

where n denotes the second threshold and N_{TA} denotes the uplink transmission timing advance of the second communication and sensing node. The second communication and sensing node obtains sensing measurement information of a distance D₁ (a distance to the target object detected by the first communication and sensing node based on a second sensing signal using the same transmitting beam as the sensing signal) between the first communication and sensing node and the target object, and calculates a second threshold based on the distance D₁, such as

$$η = \frac{{D}_{1}}{c} ,$$

where η denotes the second threshold, D₁ denotes the distance between the first communication and sensing node and the target object, and c denotes the speed of light.

The second communication and sensing node obtains the time delay or the relative time delay of the strongest path/first path obtained by the first communication and sensing node based on the detection of the second sensing signal using the same transmitting beam as the sensing signal, denoted as τ, and calculates the second threshold based on τ, such as

$$η = \frac{τ}{2} ,$$

where η denotes the second threshold. By this method, since the first communication and sensing node, the target object, and the second communication and sensing node form three vertices of a triangle, when the sensing signal sent by the first communication and sensing node reaches the receiving end of the second communication and sensing node through the reflection of the target object, the time delay of the path corresponding to the target object detected by the second communication and sensing node performing the second sensing measurement based on this sensing signal should satisfy the limitation of lengths of three sides of the triangle. Specifically, the time delay is greater than a time delay corresponding to the distance between the first communication and sensing node and the second communication and sensing node, and the time delay is greater than a time delay corresponding to the distance between the first communication and sensing node and the target object.

The second plurality of paths may be detection paths with a time delay or a relative time delay less than or equal to a third threshold indicating a fixed value or obtained by the second communication and sensing node through configuration information. By this method, the second communication and sensing node detects only a scattering target object in the environment within a range which is less than a certain distance, the processes of measurement and reporting are simplified, and the method may be applied to sensing scenarios that require high identification of sensing targets within a certain distance range, such as indoor sensing. The second plurality of specific paths satisfies at least one of a power or an average power of channel response exceeding a first threshold, a time delay or a relative time delay being greater than or equal to a second threshold, and a time delay or a relative time delay being less than or equal to a third threshold.

When there is a transmission and reception timing error between the second communication and sensing node and the first communication and sensing node, the second communication and sensing node calculates the time or the relative time (time delay or relative time delay) of the detection path in the sensing measurement, which can compensate for the error between the reception timing and the transmission timing. The result of the second sensing measurement may be determined according to the comparison of the time delay or relative time delay of the detection path after compensating for the timing error with the second threshold. When the second communication and sensing node is a terminal and the first communication and sensing node is a base station, the second communication and sensing node has a timing error at the start boundary of the downlink received subframe compared to the start boundary of the downlink transmitted subframe of the first communication and sensing node.

The timing error may be obtained in advance by the uplink timing of the second communication and sensing node, e.g.,

$$Δ = \frac{{N}_{T A}}{2} ,$$

where Δ denotes the timing error and N_{TA} denotes the uplink transmission timing advance of the second communication and sensing node. Then, the method of compensating for the timing error by the time delay or relative time delay of the detection path of the second communication and sensing node may be N_{Rx,path}+Δ, wherein N_{Rx,path} denotes the time delay or relative time delay of any detection path of the second communication and sensing node.

The result of the second sensing measurement may further include at least one of identification information or index information of the first communication and sensing node, related information of a received beam used by the second communication and sensing node to receive one or more of the at least one sensing signal, and indication information indicating that a valid sensing measurement result is not obtained.

For example, the result of the second sensing measurement may also include an identification code or index of the first communication and sensing node. When the second communication and sensing node receives multiple sensing signals sent by multiple first communication and sensing nodes for sensing measurements respectively, the inclusion of the identification code or index of the first communication and sensing node in the result of the second sensing measurement may indicate a particular first communication and sensing node to which the sensing signal on which the reported result of the sensing measurement is based is sent.

The result of the second sensing measurement may also include related information of a received beam used by the second communication and sensing node to receive the sensing signal to calculate the result of the second sensing measurement, such as an index of the received beam, a direction of the received beam, etc. By this method, the beam direction of the second communication and sensing node receiving the sensing signal may be used as broad information about an direction angle Y′ of the target object in FIG. 7 to be described below.

When the result of the second sensing measurement includes time delay related measurement information for a plurality of detection paths, the SF may determine, based on the received beam direction of the second communication and sensing node, an invalid result of the plurality of detection paths included in the result of the second sensing measurement which does not correspond to the target object. For example, when the SF calculates the direction angle Ψ′ of the target object based on the time delay related measurement information of a certain detection path in the result of the second sensing measurement, if Ψ′ deviates by more than a threshold from the beam direction of the sensing signal received by the second communication and sensing node, this may indicate that the measurement result of the detection path is invalid. The result of the sensing measurement may further include indication information indicating that valid sensing measurement information is not obtained, i.e., an indication of a failed sensing measurement for indicating that valid sensing measurement information is not obtained by performing sensing detection according to the related configuration of the sensing signal.

As described above in FIGS. 4 and 5, the first communication and sensing node may report the result of the first sensing measurement to at least one object, and the second communication and sensing node may report the result of the second sensing measurement to at least one object. The objects to which the first communication and sensing node and the second communication and sensing node report their respective results of the sensing measurements may be identical or different. For example, the first communication and sensing node may report the result of the first sensing measurement to the second communication and sensing node, the second communication and sensing node may report the result of the second sensing measurement to the first communication and sensing node, and the first communication and sensing node and the second communication and sensing node both report the result of the first sensing measurement and the result of the second sensing measurement to the same base station/core network/location server/LMF/CPU/SF), respectively. Preferably, the object to which the first communication and sensing node reports the result of the first sensing measurement is identical to the object to which the second communication and sensing node reports the result of the second sensing measurement.

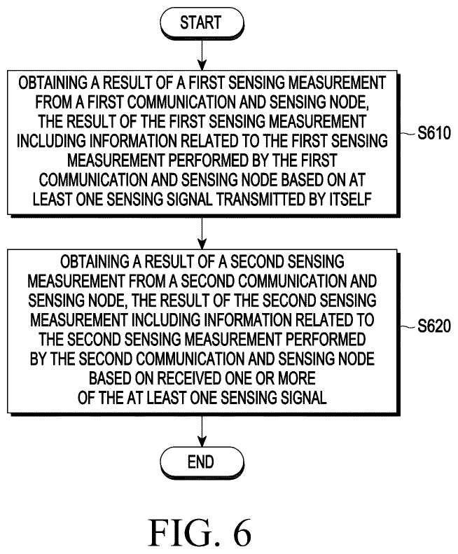

FIG. 6 illustrates a method for sensing detection according to an embodiment.

Referring to FIG. 6, at step S610, a result of a first sensing measurement from a first communication and sensing node is obtained. At step S620, a result of a second sensing measurement from a second communication and sensing node is obtained. The execution order of the steps in FIG. 6 may be changed.

The result of the first sensing measurement includes information related to the first sensing measurement performed by the first communication and sensing node based on at least one sensing signal the node as the node sends, and the result of the second sensing measurement includes information related to the second sensing measurement performed by the second communication and sensing node based on received one or more of the at least one sensing signal. The contents such as the result of the first sensing measurement and the result of the second sensing measurement, etc. have been described in the description of FIGS. 4 and 5, and will not be repeated here.

The result of the first sensing measurement and the result of the second sensing measurement may be used to perform sensing detection of a target object. The method shown in FIG. 6 may further include performing sensing detection of the target object based on the result of the first sensing measurement and the result of the second sensing measurement. Since different communication and sensing nodes (the first communication and sensing node and the second communication and sensing node) perform the first sensing measurement and the second sensing measurement based on the same sensing signal respectively, so that the result of the first sensing measurement and the result of the second sensing measurement contain a sensing measurement result for the same target object, and thus the sensing detection of the target object may be performed more accurately by performing the sensing detection based on both the result of the first sensing measurement and the result of the second sensing measurement, thereby improving the performance of sensing detection. For example, different communication and sensing nodes report their respective results of sensing measurements to the same entity, which can achieve aggregation of the results of the sensing measurements of the same target object, and thus achieve accurate localization of the target object. For example, the result of the first sensing measurement and the result of the second sensing measurement may be used to determine an direction angle of the target object to the first communication and sensing node, and/or an direction angle of the target object to the second communication and sensing node.

The above “performing sensing detection of the target object based on the result of the first sensing measurement and the result of the second sensing measurement” may include: determining a direction angle of the target object to the first communication and sensing node, and/or an direction angle of the target object to the second communication and sensing node based on the result of the first sensing measurement and the result of the second sensing measurement.

As mentioned above, the result of the first sensing measurement may include distance information (e.g., a first distance) between the first communication and sensing node and the target object, and the result of the second sensing measurement may include a sum of a first distance between the first communication and sensing node and the target object and a second distance between the second communication and sensing node and the target object.

FIG. 7 illustrates a method for sensing detection 700, according to an embodiment.

Referring to FIG. 7, the communication and sensing node #1 710 and the communication and sensing node #2 720 are both base stations. The communication and sensing node #1 710 receives an echo signal of a sensing signal 730 that node #1 710 sends and obtains a result 740 of a first sensing measurement based on the received echo signal. The result 740 of the first sensing measurement may contain information about a sensing distance D₁ 780 calculated based on a time delay of the strongest path among a plurality of paths detected according to the sensing signal. The communication and sensing node #2 720 may be configured to receive the sensing signal 730 sent by the communication and sensing node #1 710 and perform a second sensing measurement based on the received sensing signal 730 to obtain a result 750 of a second sensing measurement, which may contain a sum of the distance information of the sensing distance D₁ 780 and a sensing distance D₂ 790, which is calculated based on a time delay of the strongest path among the plurality of paths detected according to the sensing signal, where D₁ 780 is the distance between the communication and sensing node #1 710 and the target object 715, and D₂ 790 is the distance between the communication and sensing node #2 720 and the target object 715.

The results of the first sensing measurement 740 including information related to the first sensing measurement and the second sensing measurement 750 including information related to the second sensing measurement are reported to the same central processor (hereinafter, center processor 770), which may obtain the distance D₁ 780 and the distance D₂ 790. The center processor may further obtain a distance D 760 between the communication and sensing node #1 710 and the communication and sensing node #2 720. The distance D 760 is determined by the station addresses of the two base stations, and is a parameter known by the central processor, or may be obtained by the communication and sensing node #1 710 and/or the communication and sensing node #2 720 based on measurements and reported to the central processor by being included in a first measurement report and/or a second measurement report. The central processor may obtain the distance D 760, the distance D₁ 780 and the distance D₂ 790, and the direction angle from the target object 715 to the communication and sensing node #1 710, and the direction angle from the target object 715 to the communication and sensing node #2 720 may be calculated according to the cosine theorem, respectively, in Equation (1) and Equation (2) as follows:

$$Φ = arccos ( \frac{{D}^{2} + {D}_{1}^{2} - {D}_{2}^{2}}{2 \cdot D \cdot {D}_{1}} ) \qquad ( 1 )$$

$$Ψ = arccos ( \frac{{D}^{2} + {D}_{2}^{2} - {D}_{1}^{2}}{2 \cdot D \cdot {D}_{2}} ) \qquad ( 2 )$$

That is, accurate localization of the target object 715 by the communication and sensing node #1 710 and/or the communication and sensing node #2 720 may be achieved. The central processor in this example may be similarly replaced with other entities, e.g., the communication and sensing node #1 710, the communication and sensing node #2 720, a core network, a location server, a LMF, a SF, etc. The communication and sensing node #1 710 and/or the communication and sensing node #2 720 may also be similarly replaced with terminals, such that the communication and sensing node #1 710 is a base station and the communication and sensing node #2 720 is a terminal, or the communication and sensing node #1 710 and the communication and sensing node #2 720 are both terminals.

The calculation of the direction angle shown in FIG. 7 is also applicable to the calculation, by communication and sensing node #1 710, of the direction angle from the target object 715 to communication and sensing node #1 710 and the direction angle from the target object 715 to communication and sensing node #2 720 based on the distance information obtained by the first communication and sensing node and the distance information from communication and sensing node #2 720. The calculation of the direction angle shown in FIG. 7 is also applicable to the calculation, by communication and sensing node #2 720, of the direction angle from the target object 715 to communication and sensing node #1 710 and the direction angle from the target object 715 to communication and sensing node #2 720 based on the distance information obtained by the second communication and sensing node and the distance information from communication and sensing node #1 710.

The methods disclosed herein improve the performance of sensing detection as well as the accuracy of sensing position of a target object.

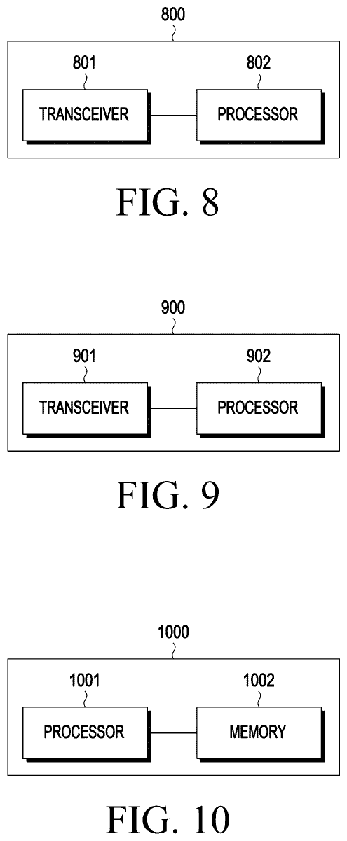

FIG. 8 illustrates a block diagram of a first communication and sensing node according to an embodiment.

Referring to FIG. 8, the first communication and sensing node 800 may include a transceiver 801 and a processor 802, wherein the processor 802 is coupled to the transceiver 801 and configured to perform the method described above in FIG. 4. For example, the first communication and sensing node 800 may be a base station or a terminal.

FIG. 9 illustrates a block diagram of a second communication and sensing node according to an embodiment.

Referring to FIG. 9, the second communication and sensing node 900 may include a transceiver 901 and a processor 902, wherein the processor 902 is coupled to the transceiver 901 and configured to perform the method described above in FIG. 5. For example, the second communication and sensing node 900 may be a base station or a terminal.

FIG. 10 illustrates a block diagram of a device for sensing detection according to an embodiment.

Referring to FIG. 10, the device 1000 for sensing detection may include a processor 1010 and a memory 1020 for storing instructions, wherein the instructions, when executed by the processor 1010, cause the device 1000 to perform the method as shown in FIG. 6. The device may be an object or an entity, for example.

As described above, a communication and sensing node that transmits a sensing signal may include a terminal or a network node (e.g., a base station, IAB). A base station as the communication and sensing node transmits a downlink sensing signal and a terminal as a communication target object receives or does not receive the downlink sensing signal. A terminal as the communication and sensing node transmits an uplink sensing signal, and a base station as the communication target object receives or does not receive the uplink physical channel/signal. A terminal as the communication and sensing node transmits a sidelink sensing signal and another terminal as the communication target object receives or does not receive the sidelink sensing signal. The configuration of physical resources may include time domain resources and/or frequency domain resources. The time domain resources may include an OFDM symbol, a time slot, a micro time slot, or a subframe, and the frequency domain resources may include a channel, a subchannel, a carrier, or a subcarrier.

In a multi-point sensing concept disclosed herein, at least a first terminal and a second terminal or a network node including a base station are involved.

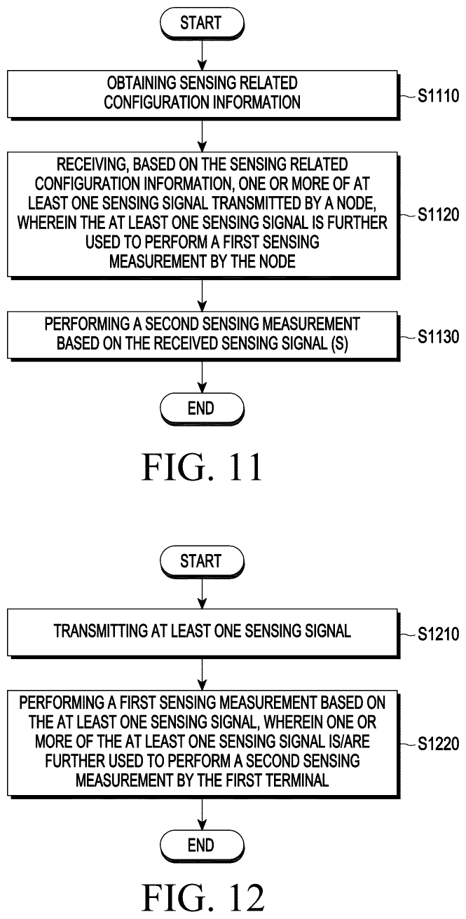

FIG. 11 illustrates a method performed by a first terminal in a communication system according to an embodiment.

Referring to FIG. 11, at step S1110, the first terminal obtains sensing related configuration information. At step S1120, one or more of at least one sensing signal is received based on the sensing related configuration information, wherein the at least one sensing signal is transmitted by a node and the at least one sensing signal is used to perform a first sensing measurement by the node. The node may be a second terminal or a network node. For example, the network node may include a servicing base station (service cell) of the first terminal, but the disclosure is not limited thereto. At step S1130, a second sensing measurement is used to perform based on the received sensing signal(s).

In particular, the sensing related configuration information may be received by at least one of: high-layer signaling, downlink control information, MAC signaling, or sidelink control information. For example, the first terminal may receive at least one of the above sensing related signaling and obtain the sensing related configuration information based on the sensing related signaling. method enables the first terminal to be configured through the sensing related signaling, to receive a sensing signal transmitted by the node, and to perform a first sensing measurement based on the sensing signal. The result of the first sensing measurement may be used for sensing detection of a target object, for positioning of the target object.

The sensing related configuration information may include at least one of configuration information of the sensing signal, enabling information for configuring the first terminal to receive the sensing signal; first indication information for indicating a sensing measurement method, second indication information related to a sensing scenario or a sensing demand, and configuration information related to a physical resource for transmitting the first information.

The sensing related configuration information may include the configuration information of the sensing signal included in the sensing related configuration information, time domain resources of the sensing signal, frequency domain resources of the sensing signal, identification information/index information of the node transmitting the sensing signal, the number of repetitions of the sensing signal, and/or a related configuration of a sequence of the sensing signal.

The time domain resources of the sensing signal may be at least one of a time domain symbol, a time slot, a subframe, a wireless frame in which the sensing signal is transmitted, and a transmission period of the sensing signal.

The frequency domain resources of the sensing signal may be at least one of a carrier, a BWP, a sub-band, an RBG, a PRB, and a sub-carrier in which the sensing signal is transmitted.

The related configuration of the sequence of the sensing signal may be used to determine the sequence of the sensing signal, and may include information indicating a type of the sequence of the sensing signal (e.g., a Zadoff-Chu (ZC) sequence, a pseudo-noise (PN) sequence, a linear frequency modulation (FM) sequence, etc.); or, may also include information indicating parameters required for computing each symbol in the sequence of the sensing signal. For example, the first terminal receives more than one signaling for determining the sensing related configuration information by being configured with a plurality of sets of sensing related configuration information based on the high-layer signaling or the MAC signaling, and is instructed via the MAC signaling or downlink control information/sidelink control information that at least one of the plurality of sets of sensing related configuration information is used for the first terminal to receive the sensing signal. This combination of quasi-static and dynamic configurations is used to achieve a compromise between configuration flexibility and signaling overhead.

The sensing related configuration information may include enabling information for configuring the first terminal to receive the sense signal. For example, the first terminal obtains the enabling information for receiving the sense signal by receiving at least one of the downlink control information, the sidelink control information, the high-layer signaling, and the MAC signaling. When the enabling information obtained by the first terminal is enabled/on, the first terminal receives the sensing signal and/or performs a sensing related measurement.

When the enabling information for receiving the sensing signal obtained by the first terminal is disabled/off, the first terminal does not receive the sensing signal and/or performs the sensing related measurement. By this method, the sensing measurement of the first terminal may be triggered as needed, thereby saving signaling overhead, resource overhead and energy consumption for the terminal to perform the sensing measurement.

The sensing related signaling may include the downlink control information or the sidelink control signaling. The downlink control information or the sidelink control information may include UE group sensing related information for a UE group of at least one first terminal, wherein the UE group sensing related information includes at least one of enabling information for configuring the at least one first terminal to receive the sensing signal, identification information for the node transmitting the sensing signal, configuration information of the sensing signal, and indication information for indicating a sensing measurement method. The UE group may include at least one first terminal, wherein each first terminal is a user.

For example, the UE group sensing related information included in the downlink control information may be UE group downlink control information, and the UE group sensing related information included in the sidelink control information may be UE group sidelink control information.

The downlink control information including the enabling information for configuring the first terminal to receive the sensed signal may be UE group downlink control information, which is enabling information for notifying a group of users including at least greater than one user to receive the sensed signal.

Based on the enabling information included in the UE group downlink control information, users notified by the same UE group downlink control information (i.e., at least one first terminal) receive or do not receive the sensing signal transmitted by the same base station or at least one second terminal. A plurality of enabling information for configuring the first terminal to receive the sensing signal may be included in the UE group downlink control information, wherein different enabling information applies to sensing signals transmitted by different nodes.

The first terminal determines an identification code of the node transmitting the sensing signal by receiving the UE group downlink control information including enabling information for a group of users to receive the sensing signal. Specifically, the UE group downlink control information includes an identification code/index/relative index of the node transmitting the sensing signal, and the enabling information which may be used to indicate that the group of users to receive the sensing signal is applicable to the sensing signal transmitted by the node configured with the identification information.

When the UE group downlink control information includes a plurality of enabling information for receiving the sensing signal, the identification information of the node transmitting the sensing signal included in the UE group downlink control information may be multiple, where each corresponds to each of the plurality of enabling information for receiving the sensing signal, respectively. By this method, a base station can configure a plurality of first terminals in close geographic proximity for auxiliary sensing detection or localization through the UE group downlink control information.

The plurality of sensing related measurements reported by the node and the plurality of first terminals may contain measurement information for the same target object, and the plurality of sensing related measurements may be aggregated for precise sensing detection or localization of the target object in sensing scenarios in which there are multiple target objects in the environment. Use of the UE group downlink control information enables a rapid configuration of the enabling information for the terminal to receive the sensing signal. The first terminal may be configured via the UE group downlink control information to include enabling information for receiving the sensing signal by a group of users greater than at least one user. The first terminal may also be configured with configuration information of the sensing signal via the UE group downlink control information or the high-layer signaling or the MAC signaling. The configuration information of the sensing signal includes but is not limited to time domain resources of the sensing signal, frequency domain resources of the sensing signal, identification information/index information of the node transmitting the sensing signal, and the number of repetitions of the sensing signal.

The first terminal obtains configuration information of at least one sensing signal via the high-layer signaling or the MAC signaling, and is instructed via the UE group downlink control information with the configured enable information for receiving one or more of at least one sensing signal. By this method, an effective compromise between configuration flexibility and overhead of signaling is achieved by configuring most of the signaling in a quasi-static manner and then configuring the enabling information of the terminal to receive the sensing signal in a dynamic manner, while ensuring that the base station configures a plurality of first terminals in close geographical proximity for auxiliary sensing detection via the UE group downlink control information.

The sensing related configuration information may include first indication information for indicating a sensing measurement method, which indication includes at least the number and types of sensing related measurement variables that the first terminal is instructed to report. These variables may include sensing signal-based measurement variables such as a received power/received multipath power/arrival time difference between transmission and reception of the sensing signal, and other sensing related measurement variables available for sensing that are detected not based or directly based on the sensing signal, such as a received beam direction of the sensing signal received by the first terminal.

The sensing related signaling including the first indication information for indicating the sensing measurement method may be downlink control signaling, such as UE group downlink control information. The first indication information for indicating the sensing measurement method may be a measurement variable that the first terminal is instructed to report, and that a measurement variable to be reported is at least one of a plurality of sensing related measurement variables.

Alternatively, a measurement variable group that the first terminal is instructed to report, and that measurement variables to be reported at least include all of the measurement variables in the instructed measurement variable group. The indication of the measurement variable group to be reported may be that at least one of a plurality of sensing related measurement variable groups is indicated for measurement reporting. For example, N₁ of N sensing related possible measurement variables/measurement variable groups are indicated for measurement reporting of the first terminal, wherein both N and N₁ are positive integers greater than or equal to 1, and N₁≤N. By this method, the calculation method, number, and type of the sensing related measurement variables required for different sensing scenarios or sensing demands may be different, and multiple sensing related measurement variables or multiple sensing related measurement variable groups may be formulated considering all the supported sensing scenarios or sensing demands.

Depending on the different sensing scenarios, the first terminal is instructed that at least one specific sensing related measurement variable/measurement variable group is used for measurement reporting. That is, each sensing related measurement variable group corresponds to a different sensing scenario and/or sensing demand. An appropriate reporting measurement variable may be selected for a specific sensing demand, thereby reducing the processing complexity of the terminal and the signaling overhead for sensing related measurement reporting.

The sensing related configuration information may include second indication information related to a sensing scenario or a sensing demand (hereinafter, the sensing scenario). The sensing scenario or sensing demand may correspond to at least one of a sensing measurement method and configuration information of a sensing signal. For example, the first terminal is instructed at least one of K sensing scenarios, and the first terminal obtains configuration information of the sensing signal, such as, a time domain resource, a frequency domain resource, or a sequence of the sensing signal, through the instructed sensing scenario based on a predetermined correspondence between the sensing scenario and the configuration information of the sensing signal.

Alternatively, the first terminal is instructed at least one of K sensing scenarios, and the first terminal obtains a sensing measurement method through the instructed sensing scenario according to a predetermined correspondence between the sensing scenario and the sensing measurement method. The sensing measurement method at least includes the first terminal determining the number and category of sensing related measurement variables to be reported, where it is assumed that the first terminal is instructed to use sensing scenario A. The sensing scenario A corresponds to a particular sensing related measurement variable (e.g., first N₁ of N predefined sensing related measurement variables, where N and N₁ are both positive integers greater than or equal to 1 and N₁≤N), the first terminal reports the first N₁ sensing related measurement variables after receiving the sensing signal.

The K sensing scenarios in the description of the first terminal being instructed at least one of K sensing scenarios may be predefined, and the difference in sensing demands under different sensing scenarios includes at least one of the number of target objects expected to be detected, whether to detect a radial distance of the target object, the maximum value of radial distances of the target object expected to be detected, a resolution of the radial distance of the target object expected to be detected, whether to detect a velocity/Doppler of the target object, a resolution of the velocity/Doppler of the target object expected to be detected, the maximum value of velocities/Dopplers of the target object expected to be detected, an angular resolution of the target object expected to be detected, and a range of echo power of the target object expected to be detected.

The sensing demands under different sensing scenarios are different, which may correspond to different configurations of the sensing signal and sensing measurement methods, respectively, so that the first terminal may implicitly obtain the configuration of the sensing signal and/or the sensing related measurement method through the correspondence between the sensing scenario and the configuration of the sensing signal and/or the sensing measurement method, which may reduce the signaling overhead.

The sensing related configuration information may further include configuration information related to a physical resource for transmitting the first information, wherein the physical resource may include at least one of: a time domain resource in which the first terminal transmits a physical channel including the first information (e.g., a radio frame/subframe/time slot/OFDM symbol, etc.), a frequency domain resource in which the first terminal transmits a physical channel including the first information (e.g., a BWP/RBG/physical resource block, etc.).

The method shown in FIG. 11 may further include, prior to step S1110, the first terminal transmitting the first information, which may include at least one of sensing related request information and sensing related capability information of the first terminal. For example, the first terminal may transmit the first information to a servicing base station of the first terminal, or to at least one second terminal. The first information transmitted by the first terminal is received by the servicing base station of the first terminal or the at least one second terminal and may be used to provide necessary information related to sensing of the servicing base station or the second terminal. This enables accurate configuration of the sensing signal and the sensing measurement method, which enables realization of the desired sensing performance.

The first information may include sensing related request information including at least one of request information for requesting a sensing signal to be transmitted, indication information about a sensing scenario or a sensing demand, related information of resource configuration for the sensing signal, information related to a requested assisting node, and a location request of the first terminal.

The first terminal requests to transmit an uplink sensing signal, such that the first terminal may transmit a sensing signal and receive an echo signal so as to obtain sensing related information (position, moving speed/Doppler frequency, directional angle, etc.) of the adjacent target object. Alternatively, by transmitting a sensing signal by the first terminal and receiving the sensing signal by the base station or the second terminal, the base station or the second terminal may obtain sensing related information (position, moving speed/Doppler frequency, directional angle, etc.) of the target object adjacent to the first terminal.

The indication information about the sensing scenario or the sensing demand may be the same as the second indication information related to the sensing scenario or the sensing demand described herein. The role of the first terminal reporting the sensing scenario and the sensing demand may be to provide the necessary information for the base station or the second terminal to perform the sensing related configuration of the first terminal. The manner of reporting by the first terminal may be to indicate that at least one of predefined K sensing scenarios or sensing demands is the current sensing scenario or the sensing demand of the first terminal.

The related information of the resource configuration for the sensing signal may be information related to a sensing signal resource configuration requested by the first terminal or may be information related to one or more sensing signal resource configurations or configuration sets selected by the first terminal among at least one configured sensing signal resource configuration or configuration set. For example, reporting the related information of the resource configuration for the sensing signal enables the first terminal to select an appropriate sensing signal resource configuration based on the sensing scenario or the sensing demand, thereby reducing additional sensing signal resource overhead For example, when a resolution of sensing distance detection of a surrounding target object is lower in the sensing priority of the first terminal, the sensing signal resource configuration selected by the first terminal may be one or more sensing signal resource configurations or configuration sets for allocating a shorter bandwidth to the sensing signal.

The information related to the requested assisting node may be index information or identification information of the assisting node. For example, the assisting node may be at least one base station or at least one second terminal. The assisting node may assist the first terminal in sensing by the first terminal being configured to transmit a sensing signal, wherein the relevant configuration of the sensing signal is transmitted by a node requested to assist the first terminal in sensing. For example, the first terminal may receive a sensing signal transmitted by itself for sensing detection, or the assisting node may receive a sensing signal transmitted by the first terminal for sensing detection. Alternatively, the first terminal may be configured to receive a sensing signal, wherein the sensing signal and its associated configuration are transmitted by the assisting node. In this case, the first terminal may obtain information about the surrounding target object by receiving the sensing signal transmitted by the assisting node. By this method, when the first terminal has sensing demands in different beam directions, the first terminal can request sensing collaboration from a node in a desired direction to achieve better sensing performance.

The location request of the first terminal may be that the first terminal requests to be configured with a positioning reference signal and perform a positioning related measurement based on the configured positioning reference signal, which may be transmitted by at least one base station or at least one second terminal, such that the first terminal transmitting the location request may determine a exact distance and/or directional angle of the first terminal to the at least one network node or the at least one second terminal. The second terminal or the base station may act as an assisted sensing node of the first terminal. The first terminal may be configured to receive a sensing signal transmitted by the second terminal, and the first terminal may obtain some information about a target object in the environment (e.g., the number of target objects, a sum of a distance from the second terminal to the target object and a distance from the same target object to the first terminal, etc.) by performing a sensing related measurement based on the sensing signal.

In addition, a relative position relationship between the first terminal and the second terminal may be obtained based on positioning. The above information may be reported to other entities (e.g., LMF) for determining the positioning information of the target object. In the sidelink communication system, when the first terminal selects a node to be requested to assist in sensing as the second terminal, the location request may be reported in an implicit manner. That is, when information reported by the first terminal about a node that is requested to assist the first terminal for sensing includes an indication that the node that is requested to assist the first terminal for sensing is the second terminal, this indicates the first terminal also makes a location request, and the positioning reference signal configured to be received by the first terminal is transmitted by the second terminal.

Alternatively, the first information may include sensing related capability information of the first terminal, which capability information may include at least one of information related to a full-duplex capability indicating that the first terminal is capable of transmitting a signal and is capable of receiving the signal, and information related to a sensing detection capability indicating that the first terminal is capable of receiving a sensing signal for at least one sensing related measurement.

The full-duplex capability indicates that the first terminal is capable of transmitting and receiving a signal. For example, the first terminal may receive an echo signal of a sensing signal the first terminal has transmitted and perform sensing detection on the echo signal. The full-duplex capability involves hardware and software capabilities, and a device with the full-duplex capability is more complex and expensive than a device without such capability. Thus, the full-duplex capability may be reported by the terminal as an optional capability.

When the first terminal has the full duplex capability, the first terminal may be configured to transmit an uplink sensing signal, and the first terminal may perform a sensing related measurement by receiving an echo signal of the sensing signal the first terminal has transmitted to obtain a part of information about a target object in the surrounding environment.

A second terminal or a base station may receive the sensing signal transmitted by the first terminal to perform a sensing related measurement while obtaining another part of information about the target object in the surrounding environment of the first terminal. These two parts of information may be simultaneously reported to other entities (e.g., LMF), and the other entities may achieve sensing detection of the target object based on the aggregated information and achieve accurate positioning of the target object.

The sensing detection capability indicates that the first terminal is capable of receiving a sensing signal for at least one sensing related measurement. Specifically, the reported information related to the sensing detection capability may be a type of sensing related detection that the first terminal may perform one or more of a distance, a velocity, or a directional angle. The reported information may also be an upper limit of performance of the first terminal for a particular type of sensing related detection such as the maximum resolution of the first terminal for distance detection, and may be whether the first terminal supports time domain and/or frequency domain sensing related measurement(s).

Since sensing detection may involve software capabilities, the maximum resolution of the first terminal for distance detection is related to the maximum received bandwidth and/or maximum number of FFT points that the terminal can support. A device with the sensing detection capability is more complex and power-consuming than a device without such capability. Thus, the sensing detection capability may be reported by the terminal as an optional capability. The information reported by the first terminal related to the sensing detection capability may be used for a base station or a second terminal to calculate relevant configuration of the sensing signal that should be received or transmitted by the first terminal. This enables the most efficient use of the physical resources of the sensing signal while ensuring optimum sensing performance.

When the sensing detection capability reported by the first terminal includes only the distance detection, the first terminal may be configured to transmit fewer sensing signals in a cycle, which reduces the frequency of transmitting the sensing signal. The first terminal may be configured to transmit or receive a sensing signal, where the determination of transmitting or receiving may be related to the sensing detection capability reported by the first terminal.

When the first terminal reports not having any sensing related detection capability, the first terminal may be configured to transmit a sensing signal and a base station or a second terminal may receive the sensing signal and perform sensing related measurement reporting. The sensing related measurement result may contain information about a target object in the environment around the first terminal. Otherwise, when the first terminal reports having the sensing related detection capability, the first terminal having full-duplex capability may be configured to transmit or receive a sensing signal, and the first terminal receives the sensing signal and performs sensing related measurement reporting.

The first information is transmitted over at least one of an uplink control channel, an uplink shared channel, a sidelink shared channel, and a sidelink control channel.

The first information may be uplink control information. The first terminal may transmit the first information by an uplink control channel of a particular format, such as an uplink control channel of a first format for transmitting only the first information or that may include the first information.

Alternatively, the first terminal may transmit the first information by carrying the uplink control information including the first information over the uplink shared channel. specifically, the first terminal is configured with resource configuration information for the uplink control channel of the first format, and transmits the uplink control channel of the first format based on this resource configuration information when there is a sensing related request. The uplink control channel of the first format includes the first information. Using the uplink control channel/uplink shared channel to report the uplink control information including the first information enables the first terminal to quickly report sensing related request information so as to receive the sensing signal for the sensing measurement as soon as possible, and may be applicable to sensing scenarios that require high sensing effectiveness.

The first information may be sidelink control information. The first terminal transmits the first information by transmitting sidelink control information containing the first information over a sidelink control channel. This method may be suitable for sensing scenarios that require high sensing effectiveness in bypass communication systems.

The first information may be MAC signaling or high-layer signaling. The first terminal may transmit the first information by transmitting MAC signaling or high-layer signaling containing the first information over an uplink shared channel or a sidelink shared channel. This method may be suitable for sensing scenarios that require low sensing effectiveness or where more sensing related contents are reported.

The first terminal may have a self-sensing capability, in addition to performing the steps described above in FIG. 11 as an assisted sensing node of a second terminal or a base station. Thus, the method in FIG. 11 may further include the first terminal transmitting one or more sensing signals and performing a sensing measurement based on the one or more sensing signals.

Performing the sensing measurement may include performing a measurement of a direction angle of a target object, but the disclosure is not limited thereto.

The method in FIG. 11 may further include reporting a result of the second sensing measurement to at least one entity, which may include at least one second terminal, a base station, a core network, a central processor, a location server (e.g., an LTE positioning protocol (LPP) server, etc.), an LMF located in the core network or a local location management function entity located in the wireless access network, and an SF located in the core network or a local sensing function entity located in the wireless access network. The result of the second sensing measurement includes information related to the second sensing measurement performed by the first terminal based on the received sensing signal, such as a second time correlation measurement result including a time or a time delay, or a relative time or a relative time delay of each of at least one path detected by the first terminal performing the second sensing measurement based on received sensing signal(s), a second power correlation measurement result including a power or a power average of channel response of each of the at least one path, and measurement information obtained based on a sum of a first distance between the first terminal and the target object and a second distance between the node transmitting at least one sensing signal and the target object.

For example, the second time correlation measurement result includes at least one of a time correlation measurement result of a second strongest path with the highest power or average power of channel response among a plurality of paths detected by the first terminal performing the second sensing measurement based on the received sensing signal(s), a time correlation measurement result of a path first detected by the first terminal performing the second sensing measurement based on the received sensing signal(s), and a plurality of time correlation measurement results of a second plurality of paths satisfying at least one condition.

The at least one condition includes at least one of a power or an average power of channel response exceeding a first threshold, the time correlation measurement result being greater than or equal to a second threshold, and the time correlation measurement result being less than or equal to a third threshold. The result of the second sensing measurement further includes at least one of identification information or index information of the node transmitting the at least one sensing signal, related information of a received beam used by the first terminal to receive one or more of the at least one sensing signal, and information indicating that a valid sensing measurement result is not obtained.

The first terminal may act as an assisted sensing node of a second terminal or a base station, or may act as an assisted sensing node of the first terminal. For example, the node may transmit at least one sensing signal and perform a first sensing measurement based on the at least one sensing signal, and the first terminal may perform a second sensing measurement based on one or more of the at least one sensing signal. Since one or more of the sensing signal transmitted by the node will be used by the first terminal and the node to perform the sensing measurements, when both the result of the first sensing measurement and the result of the second sensing measurement are used for sensing detection of the same target object, it is possible to perform sensing detection of the target object more accurately.

FIG. 12 illustrates a method performed by a node according to an embodiment.

Referring to FIG. 12, at step S1210, the node (e.g., a second terminal or a network node, such as a servicing base station of the first terminal) transmits at least one sensing signal. At step S1220, the node performs a first sensing measurement based on the at least one sensing signal. One or more of the at least one sensing signal is/are further used to perform a second sensing measurement by the first terminal.

The method in FIG. 12 further includes transmitting sensing related configuration information to the first terminal by at least one of high-layer signaling, downlink control information, MAC signaling, and sidelink control information. The sensing related signaling and the sensing related configuration information have been described above, and thus will not be repeated here.

The method in FIG. 12 may further include receiving a first information from the first terminal, wherein the first information includes at least one of: sensing related request information and sensing related capability information of the first terminal. The first information is received over at least one of: an uplink control channel, an uplink shared channel, a sidelink shared channel, and a sidelink control channel. The contents related to the first information have been described above, and thus will not be repeated here.

The method in FIG. 12 may further include reporting a result of the first sensing measurement to at least one entity, wherein the result includes information related to the first sensed measurement. The at least one entity may include at least one of: at least one first terminal, a base station, a core network, a central processor, a location server (e.g., a LTE positioning protocol (LPP) server, etc.), an LMF entity located in the core network or a local location management function entity located in the wireless access network, and an SF entity located in the core network or a local sensing function entity located in the wireless access network. The result of first sensing measurement may include at least one of: a first time correlation measurement result including a time or a time delay, or a relative time or a relative time delay, of each of at least one path detected by the node performing the first sensing measurement based on the at least one sensing signal, a first power correlation measurement result including a power or a power average of channel response of each of the at least one path, and measurement information obtained based on the first time correlation measurement result (e.g., distance information between the node transmitting the at least one sensing signal and the target object). For example, the first time correlation measurement result includes at least one of a time correlation measurement result of a first strongest path with the highest power or average power of channel response among a plurality of paths detected by the node performing the first sensing measurement based on the at least one sensing signal, a time correlation measurement result of a path first detected by the node performing the first sensing measurement based on the at least one sensing signal, and a plurality of time correlation measurement results of a first plurality of paths satisfying at least one condition including at least one of a power or an average power of channel response exceeding a fourth threshold, the time correlation measurement result being greater than or equal to a fifth threshold, and the time correlation measurement result being less than or equal to a sixth threshold. The result of the first sensing measurement further includes at least one of identification information or index information of the node transmitting the at least one sensing signal, related information of a transmitting beam used by the node to transmit the at least one sensing signal, and information indicating that a valid sensing measurement result is not obtained.

As described above in FIGS. 11 and 12, the first terminal may act as an assisted sensing node of the base station, or the base station may act as an assisted sensing node of the first terminal. The first terminal may report the result of the second sensing measurement to at least one entity and the node (base station) may report the result of the first sensing measurement to at least one entity. It is assumed that the entities to which the first terminal and the node report the results of the sensing measurements are the same entity (e.g., an SF entity).

As described above, a method performed by an entity may include obtaining a result of a first sensing measurement from a node, including information related to the first sensing measurement performed by the node based on at least one sensing signal, and obtaining a result of a second sensing measurement from a first terminal, including information related to the second sensing measurement performed by the first terminal based on received one or more of the at least one sensing signal. The results of the first and second sensing measurements are used to perform sensing detection of target object(s). Since the node and the first terminal perform the first sensing measurement and the second sensing measurement based on the same sensing signal, respectively, the results of the first and second sensing measurements include the sensing measurement results of the same target object. This enables sensing detection of the target object to be performed more accurately by performing sensing detection based on both the results of the first and second sensing measurements, thereby improving the sensing detection performance. For example, if the result of the second sensing measurement from the first terminal and the result of the first sensing measurement from the second terminal or the network node are reported to the same entity, the entity may realize aggregation of the sensing measurement results of the same target object, and thus may realize accurate localization of the target object. For example, a direction angle of the target object to the first terminal, and/or a direction angle of the target object to the second terminal or network node may be determined based on the result of the second sensing measurement from the first terminal and the result of the first sensing measurement from the second terminal or the base station.

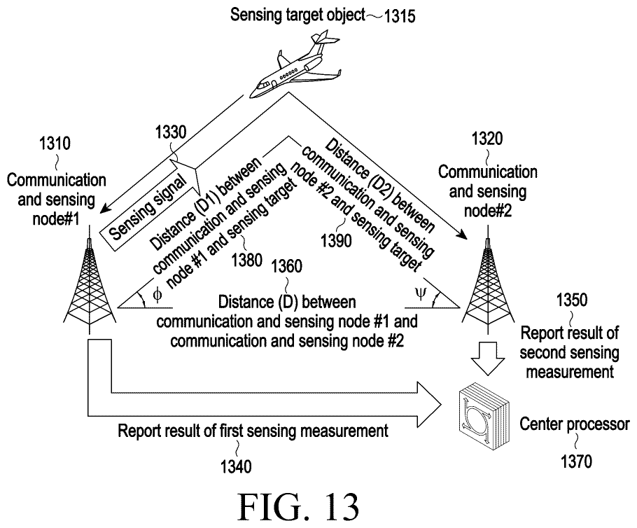

FIG. 13 illustrates an example 1300 of performing sensing detection of a target object according to an embodiment.

Referring to FIG. 13, a communication and sensing node #1 1310 is a second terminal or a base station, and a communication and sensing node #2 1320 is a first terminal. Both the communication and sensing node #1 1310 and the communication and sensing node #2 1320 report sensing related measurement reports to a center processor. The communication and sensing node #1 1310 transmits at least one sensing signal and performs a first sensing measurement based on the at least one sensing signal. For example, the communication and sensing node #1 1310 receives an echo signal of a sensing signal 1330 that node #1 has transmitted, obtains a result of a first sensing measurement based on the received echo signal and reports the result 1340 of the first sensing measurement to a center processor 1370. For example, the result 1340 of the first sensing measurement may contain information about a sensing distance D₁ 1380, which is calculated based on a time delay of the strongest path among a plurality of paths detected according to the sensing signal. The communication and sensing node #2 1320 may be configured to receive the sensing signal transmitted by the communication and sensing node #1 1310 and perform a second sensing measurement based on the received sensing signal to obtain a result 1350 of a second sensing measurement and reports the result 1350 of the second sensing measurement to the center processor 1370. For example, the result 1350 of the second sensing measurement may contain a sum of the distance information of sensing distance D₁ 1380 and sensing distance D₂ 1390 (e.g., calculated based on a time delay of the strongest path among the plurality of paths detected according to the sensing signal), where D₁ 1380 is the distance between the communication and sensing node #1 1310 and the target object 1315, and D₂ 1390 is the distance between the communication and sensing node #2 1320 and the target object 1315. The result 1340 of the first sensing measurement and the result 1350 of the second sensing measurement are reported to the same center processor 1370, which may obtain distance D₁ 1380, distance D₂ 1390 and a distance D 1360 between the communication and sensing node #1 1310 and the communication and sensing node #2 1320. The distance D 1360 is determined by the station addresses of the two base stations, and is a parameter known by the center processor 1370, or is obtained by the communication and sensing node #1 1310 and/or the communication and sensing node #2 1320 based on measurements and is reported to the center processor 1370 by being included in the second sensing measurement results 1340, 1350. The center processor 1370 may obtain distance D 1360, distance D₁ 1380 and distance D₂ 1390 and the direction angle from the target object 1315 to the communication and sensing node #1 1310, and the direction angle from the target object 1315 to the communication and sensing node #2 1320 may be calculated according to the cosine theorem, respectively in Equation (3) and Equation (4) as follows:

$$Φ = arccos ( \frac{{D}^{2} + {D}_{1}^{2} - {D}_{2}^{2}}{2 \cdot D \cdot {D}_{1}} ) \qquad ( 3 )$$

$$Ψ = arccos ( \frac{{D}^{2} + {D}_{2}^{2} - {D}_{1}^{2}}{2 \cdot D \cdot {D}_{2}} ) \qquad ( 4 )$$

That is, accurate localization of the target object 1315 by the communication and sensing node #1 1310 and/or the communication and sensing node #2 1320 may be achieved. The center processor 1370 may be similarly replaced with other entities, e.g., the communication and sensing node #1 1310, the communication and sensing node #2 1320, a core network, a location server, an LMF, or an SF.

Based on the above-described multi-node sensing methods, the performance of sensing detection is improved by the accuracy of the sensing position of a target object being improved.

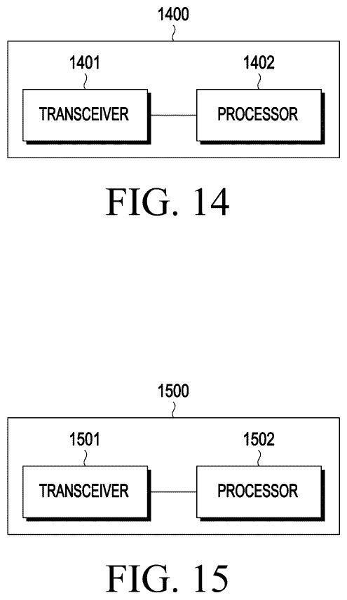

FIG. 14 illustrates a block diagram of a first terminal according to an embodiment.

Referring to FIG. 14, the first terminal 1400 may include a transceiver 1401 and a processor 1402 coupled to the transceiver 1401 and configured to perform the method described above in FIG. 11.

FIG. 15 illustrates a block diagram of a node according to an embodiment.

Referring to FIG. 15, the node 1500 may include a transceiver 1501 and a processor 1502 coupled to the transceiver 1501 and configured to perform the method described above in FIG. 12.

As described above, a method performed by a first terminal in a communication system includes obtaining sensing related configuration information, receiving, based on the sensing related configuration information, one or more of at least one sensing signal transmitted by a node, wherein the at least one sensing signal is further used to perform a first sensing measurement by the node, performing a second sensing measurement based on the received sensing signal(s).

The method further includes transmitting first information, wherein the first information includes at least one of sensing related request information, and sensing related capability information of the first terminal.

The sensing related configuration information is received by at least one of high-layer signaling, downlink control information, MAC signaling, and sidelink control information.

The node includes a second terminal or a network node, wherein the network node includes a servicing base station of the first terminal.

The sensing related configuration information includes at least one of configuration information of the sensing signal, enabling information for configuring the first terminal to receive the sensing signal, first indication information for indicating a sensing measurement method, second indication information related to a sensing scenario or a sensing demand, configuration information related to a physical resource used to transmit the first information.

The sensing related request information includes at least one of request information for requesting the sensing signal to be transmitted, indication information related to a sensing scenario or a sensing demand, related information of resource configuration for the sensing signal, information related to a requested assisting node, and a location request of the first terminal.

The sensing related capability information includes at least one of information related to a full-duplex capability, wherein the full-duplex capability indicates that the first terminal is capable of transmitting a signal and is capable of receiving the signal, information related to a sensing detection capability, and wherein the sensing detection capability indicates that the first terminal is capable of receiving a sensing signal for at least one sensing related measurement.

The first information is transmitted over at least one of an uplink control channel, an uplink shared channel, a sidelink shared channel, and a sidelink control channel.

The downlink control information or the sidelink control information includes UE group sensing related information for a UE group of at least one first terminal, wherein the UE group sensing related information includes at least one of enabling information for configuring the at least one first terminal to receive the sensing signal, identification information of the node transmitting the sensing signal, configuration information of the sensing signal, and indication information for indicating a sensing measurement method.

The method further includes reporting a result of the second sensing measurement to at least one entity, wherein the second sensing measurement result includes information related to the second sensing measurement.

As described above, a method performed by a node includes transmitting at least one sensing signal, performing a first sensing measurement based on the at least one sensing signal, wherein one or more of the at least one sensing signal is/are further performed a second sensing measurement by a first terminal.

The method further includes receiving first information from the first terminal, wherein the first information includes at least one of sensing related request information, sensing related capability information of the first terminal.

The method further includes transmitting sensing related configuration information to the first terminal by at least one of high-layer signaling, downlink control information, MAC signaling, and sidelink control information.

The sensing related configuration information includes at least one of configuration information of the sensing signal, enabling information for configuring the first terminal to receive the sensing signal, first indication information for indicating a sensing measurement method, second indication information related to a sensing scenario or a sensing demand, and configuration information related to a physical resource used to transmit the first information.

The sensing related request information includes at least one of request information for requesting the sensing signal to be transmitted, indication information related to a sensing scenario or a sensing demand, related information of resource configuration for the sensing signal, information related to a requested assisting node, and a location request of the first terminal.

The sensing related capability information includes at least one of information related to a full-duplex capability, wherein the full-duplex capability indicates that the first terminal is capable of transmitting a signal and is capable of receiving the signal, information related to a sensing detection capability, and wherein the sensing detection capability indicates that the first terminal is capable of receiving a sensing signal for at least one sensing related measurement.

The first information is received by at least one of an uplink control channel, an uplink shared channel, a sidelink shared channel, and a sidelink control channel.

The downlink control information or the sidelink control information includes UE group sensing related information for a UE group of at least one first terminal, wherein the UE group sensing related information includes at least one of enabling information for configuring the at least one first terminal to receive the sensing signal, identification information of the node transmitting the sensing signal, configuration information of the sensing signal, and indication information for indicating a sensing measurement method.

The method further includes reporting a result of the first sensing measurement to at least one entity, wherein the result of the first sensing measurement includes information related to the first sensing measurement.

As described above, a first terminal, includes a transceiver, and a processor, coupled to the transceiver and configured to perform the above method performed by a first terminal.

As described above, a node, includes a transceiver, and a processor, coupled to the transceiver and configured to perform the above method performed by a node.

As described herein, disclosed is a computer readable storage medium storing instructions, wherein the instructions, when run by at least one processor, cause the at least one processor to perform any of the methods described herein.

As described above, the node transmits at least one sensing signal and performs a first sensing measurement based on the at least one sensing signal, and one or more of the at least one sensing signal is used to perform a second sensing measurement by the first terminal. Since one or more of the sensing signal transmitted by the node may be used by the first terminal and the node to perform the sensing measurements, when both the result of the first sensing measurement and the result of the second sensing measurement are used for sensing detection of the same target object, it is possible to perform sensing detection of the target object more accurately and improve the sensing detection performance.

A computer readable storage medium storing instructions is also provided herein. The instructions, when executed by at least one processor, cause the at least one processor to perform any of the methods according to the disclosed embodiments. Examples of computer-readable storage media herein include read only memory (ROM), random access programmable read only memory (RAPROM), electrically erasable programmable read only memory (EEPROM), random access memory (RAM), dynamic RAM (DRAM), static RAM (SRAM), flash memory, non-volatile memory, compact disc (CD)-ROM, DVD-ROM, DVD-RAM, blue-ray disc (BD)-ROM, Blue-ray or optical disk storage, hard disk drive (HDD), Solid State Drive (SSD), secure digital (SD) cards or extremely fast digital (XD) cards, magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device, such as client, host, proxy device, server, etc. In addition, in one example, the computer programs and any associated data, data files, and data structures are distributed on a networked computer system, so that the computer programs and any associated data, data files, and data structures are stored, accessed and executed through one or more processors or computers in a distributed manner.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a first communication and sensing node in a wireless communication system, the method comprising:
transmitting at least one sensing signal; and
performing a first sensing measurement based on the at least one sensing signal,
wherein one or more of the at least one sensing signal is further used to perform a second sensing measurement by a second communication and sensing node.

2. The method of claim 1, further comprising:
reporting a result of the first sensing measurement to at least one object,
wherein the result of the first sensing measurement comprises information related to the first sensing measurement.

3. The method of claim 2, wherein the at least one object comprises at least one of:
at least one second communication and sensing node, a base station, a core network, a central processor, a location server, a location management function entity, and a sensing function entity.

4. The method of claim 2, wherein the result of the first sensing measurement comprises at least one of:
a first time related measurement result including a time or a time delay, or a relative time or a relative time delay, of each of at least one path detected by the first communication and sensing node performing the first sensing measurement based on the at least one sensing signal;
a first power related measurement result including a power or a power average of channel response at each of the at least one path; and
measurement information obtained based on the first time related measurement result.

5. The method of claim 4, wherein the first time related measurement result comprises at least one of:
a time related measurement result of a first strongest path with a highest power or average power of channel response among a plurality of paths detected by the first communication and sensing node performing the first sensing measurement based on the at least one sensing signal;
a time related measurement result of a path first detected by the first communication and sensing node performing the first sensing measurement based on the at least one sensing signal; and
a plurality of time related measurement results of a first plurality of paths of the plurality of paths satisfying at least one condition.

6. The method of claim 5, wherein the at least one condition comprises at least one of:
a power or an average power of channel response exceeds a fourth threshold;
the time related measurement result is greater than or equal to a fifth threshold; and
the time related measurement result is less than or equal to a sixth threshold.

7. The method of claim 4, wherein the result of the first sensing measurement further comprises at least one of:
identification information or index information of the first communication and sensing node;
related information of a transmitting beam used by the first communication and sensing node to transmit the at least one sensing signal; and
information indicating that a valid sensing measurement result is not obtained.

8. The method of claim 1, further comprising:
receiving, from the second communication and sensing node, a result of the second sensing measurement,
wherein the result of the second sensing measurement comprises information related to the second sensing measurement.

9. The method of claim 8, wherein the result of the second sensing measurement comprises at least one of:
a second time related measurement result including a time or a time delay, or a relative time or a relative time delay, of each of at least one path detected by the second communication and sensing node performing the second sensing measurement based on at least one received sensing signal;
a second power related measurement result including a power or a power average of a channel response at each of the at least one path; and
measurement information obtained based on the second time related measurement result.

10. The method of claim 9, wherein the second time related measurement result comprises at least one of:
a time related measurement result of a second strongest path with a highest power or average power of channel response among a plurality of paths detected by the second communication and sensing node performing the second sensing measurement based on the at least one received sensing signal;
a time related measurement result of a path first detected by the second communication and sensing node performing the second sensing measurement based on the at least one received sensing signal; and
a plurality of time related measurement results of a second plurality of paths of the plurality of paths satisfying at least one condition.

11. The method of claim 10, wherein the at least one condition comprises at least one of:
a power or an average power of channel response exceeds a first threshold;
the time related measurement result is greater than or equal to a second threshold; and
the time related measurement result is less than or equal to a third threshold.

12. The method of claim 9, wherein the result of the second sensing measurement further comprises at least one of:
identification information or index information of the first communication and sensing node;
related information of a received beam used by the second communication and sensing node to receive one or more of the at least one sensing signal; and
indication information indicating that a valid sensing measurement result is not obtained.

13. The method of claim 8, wherein the result of the first sensing measurement and the result of the second sensing measurement are used to calculate a direction angle from a target object to the first communication and sensing node, and/or a direction angle from the target object to the second communication and sensing node.

14. The method of claim 1, further comprising:
transmitting configuration information related to the at least one sensing signal.

15. A method performed by a second communication and sensing node in a wireless communication system, the method comprising:
receiving, from at least one first communication and sensing node, one or more of at least one sensing signal, wherein the at least one sensing signal is used to perform a first sensing measurement by the first communication and sensing node; and
performing a second sensing measurement based on the at least one received sensing signal.

16. A first communication and sensing node in a wireless communication system, the first communication and sensing node comprising:
a transceiver; and
at least one processor, coupled to the transceiver and configured to:
transmit at least one sensing signal, and
perform a first sensing measurement based on the at least one sensing signal,
wherein one or more of the at least one sensing signal is further used to perform a second sensing measurement by a second communication and sensing node.

17. The first communication and sensing node of claim 16, wherein the at least one processor is further configured to:
report a result of the first sensing measurement to at least one object,
wherein the result of the first sensing measurement comprises information related to the first sensing measurement.

18. The first communication and sensing node of claim 16, wherein the at least one processor is further configured to:
receive, from the second communication and sensing node, a result of the second sensing measurement,
wherein the result of the second sensing measurement comprises information related to the second sensing measurement.

19. The first communication and sensing node of claim 17, wherein the result of the first sensing measurement comprises at least one of:
a first time related measurement result including a time or a time delay, or a relative time or a relative time delay, of each of at least one path detected by the first communication and sensing node performing the first sensing measurement based on the at least one sensing signal;
a first power related measurement result including a power or a power average of channel response at each of the at least one path; and
measurement information obtained based on the first time related measurement result.

20. A second communication and sensing node in a wireless communication system, comprising:
a transceiver; and
at least one processor, coupled to the transceiver and configured to:
receive, from at least one first communication and sensing node, one or more of at least one sensing signal, wherein the at least one sensing signal is used to perform a first sensing measurement by the first communication and sensing node, and
perform a second sensing measurement based on the at least one received sensing signal.
